(19) United States
(12) Patent Application Publication
(10) Pub. No.: US 2013/0193816 A1
(43) Pub. Date: Aug. 1, 2013

(54) VEHICLE DRIVE DEVICE

(71) Applicants: Mikio IWASE, Anjo (JP); Daiki SUYAMA, Anjo (JP); Naoya JINNAI, Anjo (JP); Tatsuya OKISHIMA, Chiryu (JP); Yuji INOUE, Nissin (JP); Yukihiko IDESHIO, Nissin (JP)

(72) Inventors: Mikio IWASE, Anjo (JP); Daiki SUYAMA, Anjo (JP); Naoya JINNAI, Anjo (JP); Tatsuya OKISHIMA, Chiryu (JP); Yuji INOUE, Nissin (JP); Yukihiko IDESHIO, Nissin (JP)

(21) Appl. No.: 13/727,152

(22) Filed: Dec. 26, 2012

Related U.S. Application Data
(60) Provisional application No. 61/592,226, filed on Jan. 30, 2012.

(30) Foreign Application Priority Data
Jan. 30, 2012 (JP) 2012-017310

(51) Int. Cl. H02K 7/00

(52) U.S. Cl. CPC H02K 7/003
USPC 310/75 R

(57) ABSTRACT

A vehicle drive device includes a rotating electrical machine; and a fluid coupling on one side and coaxial with the electrical machine. A rotor is coupled to a housing of the fluid coupling via a disk-like member. The disk-like member is coaxial with the electrical machine, and includes a main body, and an outer fixing portion. The main body is disk-shaped and between the electrical machine and the fluid coupling. The fluid coupling includes joint fixed to the outer fixing portion. The outer fixing portion has a truncated conical surface, a diameter of which increases from the electrical machine to the fluid coupling. The joint is fixed to the rotary housing where it overlaps the rotary housing viewed in an axial direction, and includes a contact surface contacted by the outer fixing portion. The contact surface does not overlap the electrical machine as viewed perpendicular to the contact surface.

### INCORPORATION BY REFERENCE

The disclosure of Japanese Patent Application No. 2012-017310 filed on Jan. 30, 2012 and U.S. Provisional Application No. 61/592,226 filed on Jan. 30, 2012 including the specification, drawings and abstract is incorporated herein by reference in its entirety.

### BACKGROUND OF THE INVENTION

The present invention relates to vehicle drive devices that include a rotating electrical machine, and a fluid coupling placed on one side in the axial direction of the rotating electrical machine with respect to the rotating electrical machine and coaxially with the rotating electrical machine.

### DESCRIPTION OF THE RELATED ART

Regarding such vehicle drive devices, there is a technique described in, e.g., Japanese Patent Application Publication No. 2006-137406 (JP 2006-137406 A) (FIGS. 1 to 3). In the description of the section “Description of the Related Art,” the names of the members in Patent Document 1 are shown in parenthesis (“[ ]”). As shown in FIG. 1 of this document, a rotor member [the rotor 12 and the drum member 13] of a rotating electrical machine [the electric motor] is coupled to a rotary housing of a fluid coupling [the torque converter 1] via a disk-like member [the plate member 10] and a joint member [the second spline shaft 11].

According to the above configuration, the rotor member [the rotor 12 and the drum member 13] is coupled to the rotary housing of the fluid coupling [the torque converter 1] via the disk-like member [the plate member 10]. Thus, axial load due to ballooning of the fluid coupling [the torque converter 1] etc. can be absorbed and reduced by the disk-like member [the plate member 10]. Accordingly, a bearing of the rotor member [the rotor 12 and the drum member 13] can be reduced in size. According to the above configuration, a rotating electrical machine unit can be easily combined with automatic transmissions including a fluid coupling [the torque converter 1] with different shapes by changing the shape of the disk-like member [the plate member 10]. Thus, drive devices for hybrid vehicles can be formed by combining the rotating electrical machine unit with many types of automatic transmissions with a small design change.

In the conventional configuration, however, in order to secure a diameter required for elastic deformation of the disk-like member [the plate member 10], a coupling-side joint portion that fixes an outer peripheral portion of the disk-like member [the plate member 10] to the rotary housing of the fluid coupling [the torque converter 1] is extended to a position outward of the rotary housing in the radial direction, and the disk-like member [the plate member 10] is fastened to the coupling-side joint portion by a bolt. This increases the radial dimension around the coupling-side joint portion, thereby making it difficult to reduce the radial dimension of the drive device. Moreover, the diameter of the fluid coupling [the torque converter 1] need be made smaller than that of the coupling-side joint portion. Accordingly, if vehicles do not have enough mount space for the drive device, it is difficult to secure a sufficient diameter of the fluid coupling [the torque converter 1], and the capability and efficiency of the fluid coupling [the torque converter 1] can be reduced.

### SUMMARY OF THE INVENTION

Accordingly, it is desired to implement a vehicle drive device capable of easily ensuring vehicle mountability by suppressing an increase in radial dimension, in a configuration in which a rotor member of a rotating electrical machine is coupled to a rotary housing of a fluid coupling via a disk-like member.

A vehicle drive device according to a first aspect of the present invention includes: a rotating electrical machine; and a fluid coupling placed on one side in an axial direction of the rotating electrical machine with respect to the rotating electrical machine, and coaxially with the rotating electrical machine. A rotor member of the rotating electrical machine is coupled to a rotary housing of the fluid coupling via a disk-like member, the disk-like member is placed coaxially with the rotating electrical machine, and includes a disk-like main body, and an outer periphery-side fixing portion integrally formed outward in a radial direction of the disk-like main body, the disk-like main body is formed in a shape of a disk that is placed between the rotating electrical machine and the fluid coupling in the axial direction, and that extends in the radial direction, the fluid coupling includes a coupling-side joint portion to which the outer periphery-side fixing portion of the disk-like member is fixed, the outer periphery-side fixing portion is formed in a shape of a truncated conical surface tilted with respect to the radial direction so that a diameter of the outer periphery-side fixing portion increases from the rotating electrical machine side to the fluid coupling side in the axial direction, the coupling-side joint portion is fixed to the rotary housing at a position where the coupling-side joint portion has a portion overlapping the rotary housing as viewed in the axial direction, and includes a joint contact surface that is contacted by the outer periphery-side fixing portion, and the joint contact surface is provided so as not to overlap the rotating electrical machine as viewed in a direction perpendicular to the joint contact surface.

As used herein, the term “rotating electrical machine” is used as a concept including all of a motor (an electric motor), a generator (an electric generator), and a motor-generator that functions both as the motor and the generator as necessary.

As used herein, the term “fluid coupling” is used as a concept including both a torque converter having a torque amplifying function and a normal fluid coupling having no torque amplifying function.

As used herein, regarding the shape of a member, the expression “extend in a certain direction” is not limited to the shapes in which the extending direction of the member is parallel to the reference direction, and the entire member or a part of the member may extend in a direction crossing the reference direction. This expression thus is used as a concept including the shapes in which the overall extending direction of the member is in a predetermined range (e.g., 20° or less) with respect to the reference direction. The reference direction herein refers to the certain direction in the above expression.

As used herein, the term “shape of a truncated conical surface” is used as a concept including all the shapes generally forming the outer peripheral surface of a truncated cone, and also including the shapes that do not partially form the outer peripheral surface of the truncated cone.

As used herein, regarding arrangement of two members, the expression “have a portion overlapping the other member as viewed in a certain direction” means that when an imaginary straight line parallel to the viewing direction is moved in each direction perpendicular to the imaginary straight line, there is at least a region where the imaginary straight line crosses both of the members. The expression “do not have a portion overlapping the other member as viewed in a certain direction” means that when the imaginary straight line parallel to the viewing direction is moved in each direction perpendicular to the imaginary straight line, there is no region where the imaginary straight line crosses both of the members.

According to the above configuration, the rotor member is coupled to the rotary housing of the fluid coupling via the disk-like member. Thus, axial load due to ballooning of the fluid coupling can be absorbed and reduced by elastic deformation of the disk-like member. This can reduce the load on a bearing that receives the axial load between the fluid coupling and the rotor member, and thus can facilitate reduction in size of the bearing. A common rotating electrical machine can be easily combined with automatic transmissions having a fluid coupling with different shapes by changing the shape of the disk-like member. Thus, drive devices for hybrid vehicles can be formed by combining the rotating electrical machine with many types of automatic transmissions with a small design change.

Moreover, according to the above configuration, the coupling-side joint portion is fixed to the rotary housing at a position where the coupling-side joint portion has a portion overlapping the rotary housing as viewed in the axial direction, and the outer periphery-side fixing portion is formed in the shape of a truncated conical surface tilted with respect to the radial direction so that a diameter of the outer periphery-side fixing portion increases from the rotating electrical machine side to the fluid coupling side in the axial direction. This can secure a diameter required for elastic deformation of the disk-like member, and can suppress an increase in radial dimension of the portion to which the coupling-side joint portion is fixed, as compared to the case where the outer periphery-side fixing portion is shaped to extend in the radial direction like the disk-like main body. This can suppress an increase in radial dimension of the vehicle drive device, whereby vehicle mountability can be easily secured.

The joint contact surface contacting the outer periphery-side fixing portion in the coupling-side joint portion is provided so as not to overlap the rotating electrical machine as viewed in the direction perpendicular to the joint contact surface. This can facilitate the operation of fixing the outer periphery-side fixing portion to the joint contact surface from radially outside the outer periphery-side fixing portion. For example, even if the outer periphery-side fixing portion is fixed to the joint contact surface by a fixing member such as a bolt, an increase in axial dimension of the vehicle drive device can be suppressed, and the operation of inserting and fixing the fixing member in a direction perpendicular to the joint contact surface can be easily performed without being obstructed by the rotating electrical machine.

The rotating electrical machine may be accommodated in a first accommodating chamber, the fluid coupling and the disk-like member may be accommodated in a second accommodating chamber that is separated from the first accommodating chamber by a partition wall, oil that is used to cool the rotating electrical machine may be present in the first accommodating chamber, and the joint contact surface may be provided so as not to overlap the first accommodating chamber as viewed in the direction perpendicular to the joint contact surface.

According to this configuration, even if the first accommodating chamber in which there is the oil for cooling the rotating electrical machine is provided so as to adjoin the second accommodating chamber accommodating the fluid coupling and the disk-like member, workability of the operation of fixing the outer periphery-side fixing portion to the joint contact portion from radially outside the outer periphery-side fixing portion can be ensured while maintaining the first accommodating chamber from the second accommodating chamber in a separated state from each other. Moreover, an increase in radial dimension of the fixing portion between the outer periphery-side fixing portion and the coupling-side joint portion can be suppressed while securing a diameter required for elastic deformation of the disk-like member.

The rotating electrical machine may be accommodated in a first accommodating chamber, the fluid coupling and the disk-like member may be accommodated in a second accommodating chamber that is separated from the first accommodating chamber by a partition wall, and a peripheral wall portion may surround an outside in the radial direction of the second accommodating chamber, an opening may be provided in a portion of the peripheral wall portion, and the portion of the peripheral wall portion may include a portion that overlaps the joint contact surface as viewed in the direction perpendicular to the joint contact surface.

As used herein, the expression “a portion that overlaps” means a portion that overlaps the joint contact surface as viewed in the direction perpendicular to the joint contact surface at any of the positions in the rotational direction when the coupling-side joint portion is rotated together with the rotary housing.

The above configuration can simplify the operation of fixing the outer periphery-side fixing portion to the coupling-side joint portion from outside of the second accommodating chamber by inserting a object for work, such as a tool, a hand, etc. through the opening. At this time, the direction perpendicular to the joint contact surface of the coupling-side joint portion and the outer periphery-side fixing portion of the disk-like member is tilted with respect to the direction parallel to the axial direction. This eliminates the need to secure a large space in the axial direction between the inner wall surface of the second accommodating chamber and the outer periphery-side fixing portion to insert the object for work. Thus, an increase in axial dimension of the vehicle drive device can be suppressed. Accordingly, vehicle mountability can be easily ensured.

The rotating electrical machine may accommodated in a first accommodating chamber, the fluid coupling and the disk-like member may be accommodated in a second accommodating chamber that is separated from the first accommodating chamber by a partition wall, the rotor member may coupled to the disk-like member via a joint member, the joint member may include a cylindrical portion formed in a cylindrical shape, and a flange portion which extends outward in the radial direction from the cylindrical portion in the second accommodating chamber and to which the disk-like member is fixed, and a sealing member may be provided between the partition wall and an outer peripheral surface of the joint member which is located on the rotating electrical machine side with respect to the flange portion.

According to the above configuration, in a configuration in which the rotating electrical machine, and the fluid coupling and the disk-like member are accommodated in separate accommodating chambers that are separated by the partition wall, the hermetic seal property between the first accommodating chamber accommodating the rotating electrical machine and the second accommodating chamber accommodating the fluid coupling can be easily ensured while coupling the rotating electrical machine to the fluid coupling via the joint member and the disk-like member. This can suppress entrance of oil into the second accommodating chamber 36 even if the oil is present in, e.g., the first accommodating chamber.

An opposing surface portion of the rotary housing which faces the disk-like member may include a radially outer portion, a radially inner portion located inward of the radially outer portion in the radial direction and located on the rotating electrical machine side in the axial direction with respect to the radially outer portion, and a stepped portion connecting the radially inner portion and the radially outer portion in the axial direction at a position between the radially inner portion and the radially outer portion in the radial direction, and the coupling-side joint portion may be fixed to the radially outer portion at a position where the coupling-side joint portion has a portion overlapping the stepped portion as viewed in the radial direction.

According to this configuration, protrusion of the coupling-side joint portion toward the disk-like member side can be suppressed while securing the volume in the rotary housing of the fluid coupling. Thus, an increase in axial dimension of the vehicle drive device can be suppressed, and vehicle mountability can be easily ensured.

The outer periphery-side fixing portion may be fixed to the coupling-side joint portion by a fastening bolt that extends through the outer periphery-side fixing portion in a fastening direction from outside in the radial direction, and the fastening direction may be a direction perpendicular to the joint contact surface.

As described above, the outer periphery-side fixing portion is formed in the shape of a truncated conical surface tilted with respect to the radial direction so that the diameter of the outer periphery-side fixing portion increases from the rotating electrical machine side to the fluid coupling side in the axial direction, and the coupling-side joint portion includes the joint contact surface that contacts the outer periphery-side fixing portion. Thus, in the case where the fixing is performed by using the fastening bolt as in this configuration, the fastening direction of the fastening bolt is tilted with respect to the axial direction. This can reduce the space in the axial direction for providing the fastening bolt, as compared to the case where the fastening direction is parallel to the axial direction. Accordingly, an increase in axial dimension of the vehicle drive device can be suppressed, and vehicle mountability can be easily ensured.

The rotor member may be coupled to the disk-like member via a joint member, the disk-like member may include an inner periphery-side fixing portion located inward of the disk-like main body in the radial direction, and the inner periphery-side fixing portion may be fixed to the joint member by a rivet that extends through the inner periphery-side fixing portion in a direction parallel to the axis direction.

According to this configuration, the inner periphery-side fixing portion of the disk-like member is fixed to the joint member by using the rivet that extends through the inner periphery-side fixing portion in the direction parallel to the axis direction. Rivets typically can reduce the length in the axial direction as compared to bolts. Thus, the axial dimension of the fixing portion between the inner periphery-side fixing portion of the disk-like member and the joint member can be reduced. As a result, an increase in axial dimension of the vehicle drive device can be suppressed, and vehicle mountability can be easily ensured

### BRIEF DESCRIPTION OF THE DRAWINGS

FIG. 1 is a schematic diagram showing a schematic configuration of a vehicle drive device according to an embodiment of the present invention;

FIG. 2 is a partial sectional view of the vehicle drive device according to the embodiment of the present invention;

FIG. 3 is a partial enlarged view of FIG. 2; and

FIG. 4 is a partial enlarged view illustrating the flow of oil.

### DETAILED DESCRIPTION OF THE EMBODIMENTS

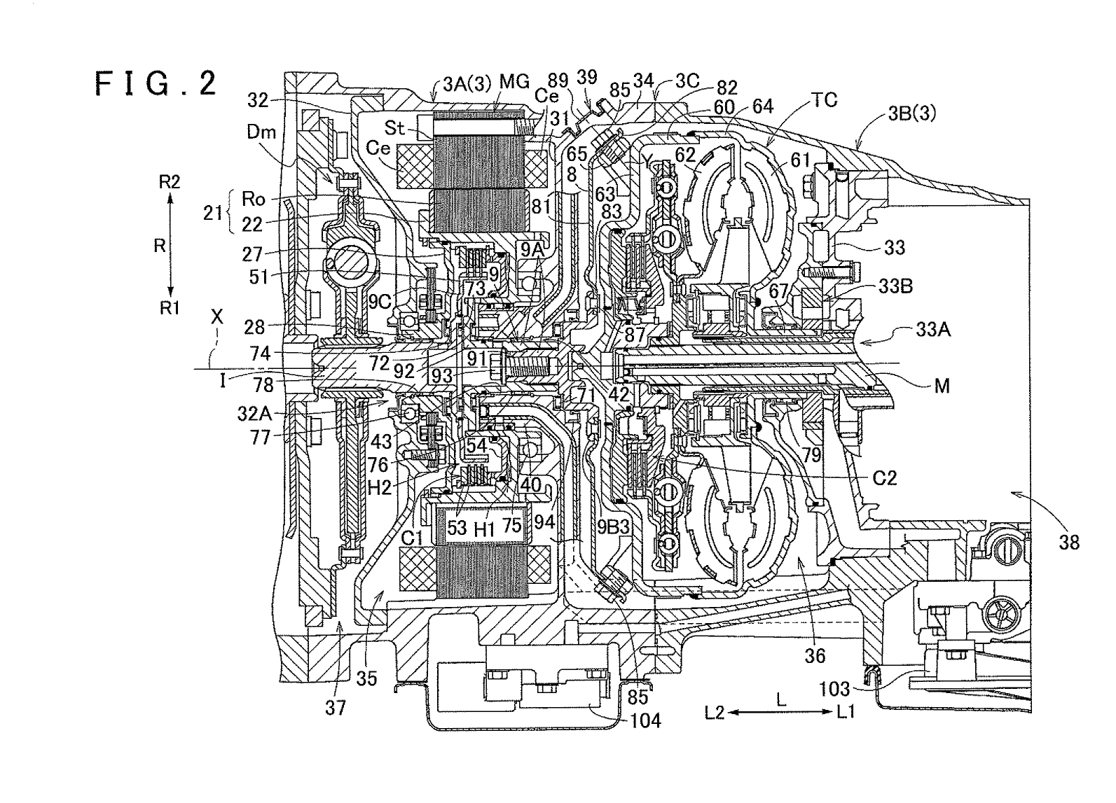

An embodiment of a vehicle drive device according to the present invention will be described with reference to the accompanying drawings. In the following description, the “axial direction L,” the “radial direction R,” and the “circumferential direction” are defined based on the central axis of rotation (the central axis X shown in FIG. 2) of a rotating electrical machine MG unless otherwise specified. The “axial first direction L1” represents the direction from the rotating electrical machine MG toward a torque converter TC along the axial direction L (the right direction in FIG. 2), and the “axial second direction L2” represents the direction opposite to the axial first direction L1 (the left direction in FIG. 2). The “radially inward direction R1” represents the direction that is inward in the radial direction R, and the “radially outward direction R2” represents the direction that is outward in the radial direction R. The direction of each member represents the direction of that member in the assembled state of a vehicle drive device 1. The terms regarding the direction, position, etc. of each member are used as a concept including a displacement according an acceptable manufacturing error.

### 1. Overall Configuration of Vehicular Drive Device

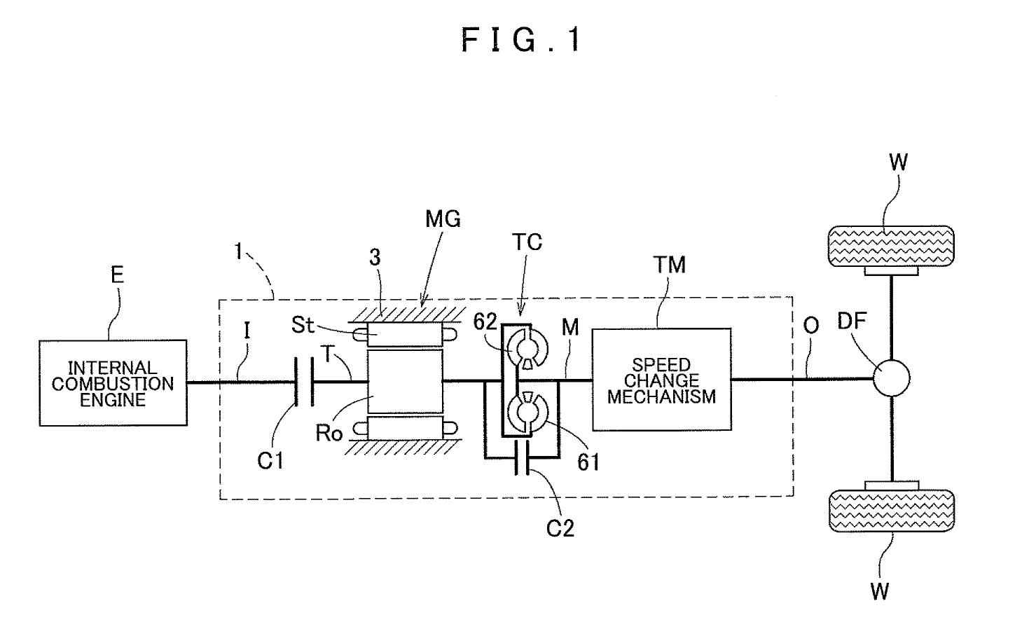

FIG. 1 is a schematic diagram showing a schematic structure of the vehicular drive device 1 according to the present embodiment. As shown in FIG. 1, the vehicular drive device 1 includes a rotating electrical machine MG, a torque converter TC, and a case 3 (see FIG. 2) accommodating the rotating electrical machine MG and the torque converter TC. The torque converter TC is drivingly coupled to the rotating electrical machine MG, and specifically, is provided in a power transmission path between the rotating electrical machine MG and an output member O. The output member O is drivingly coupled to wheels W via an output differential gear unit DF, and rotation and torque transmitted to the output member O are distributed and transmitted to the two wheels W, namely the right and left wheels W, via the output differential gear unit DF. Thus, the vehicle drive device 1 is capable of transmitting the torque of the rotating electrical machine MG to the wheels W to move a vehicle. In the present embodiment, the torque converter TC corresponds to the “fluid coupling” in the present invention.

The vehicle drive device 1 according to the present embodiment is also capable of transmitting the torque of an internal combustion engine E to the wheels W to move the vehicle. That is, the vehicle drive device 1 includes an input member I that is drivingly coupled to the internal combustion engine E, and as shown in FIG. 1, the input member I, the rotating electrical machine MG, the torque converter TC, and the output member O are sequentially provided in that order starting from the internal combustion engine E side in the power transmission path coupling the internal combustion engine E to the wheels W. Thus, the vehicle drive device 1 according to the present embodiment is configured as a drive device for hybrid vehicles (a hybrid drive device) which uses one or both of the internal combustion engine E and the rotating electrical machine MG as a driving force source of the wheels W. Specifically, the vehicle drive device 1 according to the present embodiment is configured as a so-called one-motor parallel type hybrid drive device.

The internal combustion engine E is a motor that is driven by fuel combustion inside the engine to output power. For example, a gasoline engine, a diesel engine, etc. can be used as the internal combustion engine E. In the present embodiment, the input member I is drivingly coupled to an output shaft (a crankshaft etc.) of the internal combustion engine E via a damper Dm (see FIG. 2, not shown in FIG. 1). The input member I may be drivingly coupled to the output shaft of the internal combustion engine E without interposing the damper Dm therebetween.

In the present embodiment, as shown in FIG. 1, a first clutch C1, functioning as an internal combustion engine separating clutch that separates the internal combustion engine E from the wheels W, is placed between the input member I and the rotating electrical machine MG in the power transmission path. A speed change mechanism TM is placed between the torque converter TC and the output member O in the power transmission path. The speed change mechanism TM is formed by a mechanism capable of changing the speed ratio in a stepped or continuously variable manner (e.g., an automatic stepped speed change mechanism, a continuously variable speed change mechanism, etc.), and shifts the rotational speed of an intermediate shaft M (a shift input shaft) at a predetermined speed ratio to transmit the shifted rotational speed to the output member O (a shift output shaft).

In the present embodiment, the input member I, the first clutch C1, the rotating electrical machine MG, the torque converter TC, the speed change mechanism TM, and the output member O are placed on the central axis X (see FIG. 2), and the vehicle drive device 1 according to the present embodiment has a single axis configuration that is suitable when mounted on front engine rear drive (FR) vehicles.

### 2. Configuration of Each Part of Vehicle Drive Device

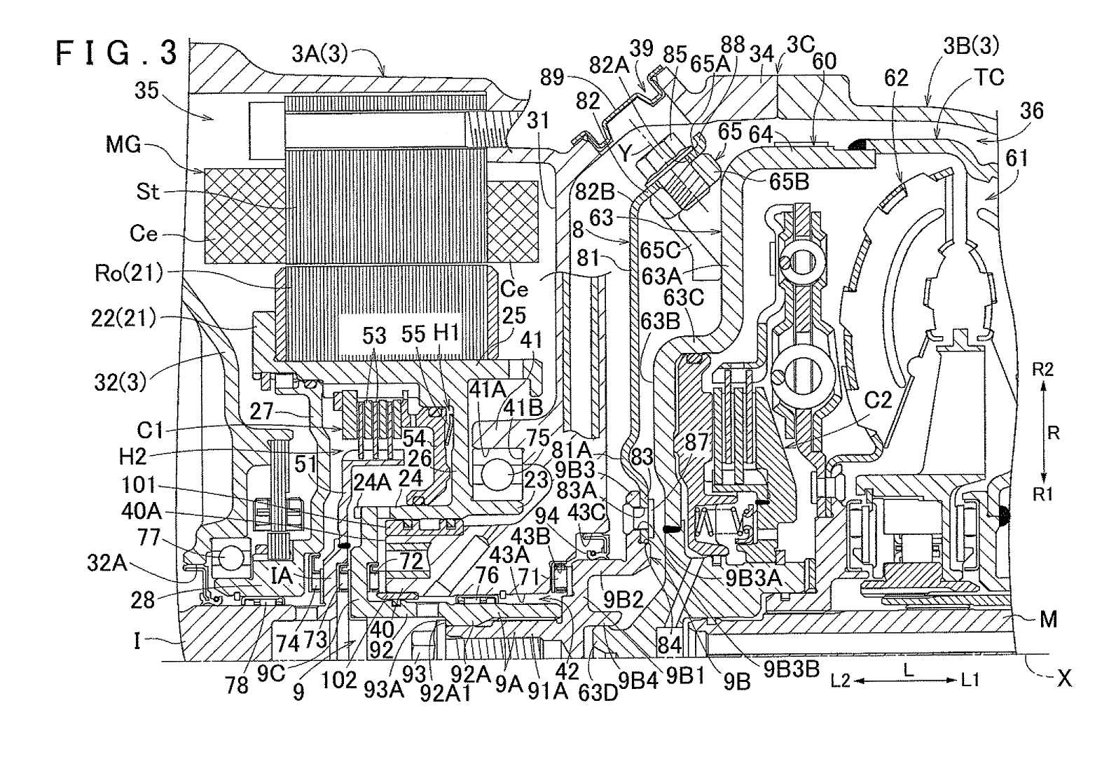

The configuration of each part of the vehicle drive device 1 according to the present embodiment will be described below with reference to FIGS. 2 and 3. FIG. 2 is a sectional view showing a part of the vehicle drive device 1 according to the present embodiment taken along a plane including the central axis X, and FIG. 3 is a partial enlarged view of FIG. 2.

2-1. Case

As shown in FIG. 2, in the present embodiment, the case 3 includes a first support wall portion 31, a second support wall portion 32, a third support wall portion 33, and a peripheral wall portion 34. The peripheral wall portion 34 is formed substantially in a cylindrical shape that surrounds the outer peripheries of the rotating electrical machine MG, the torque converter TC, a flex plate 8, etc. The second support wall portion 32, the first support wall portion 31, and the third support wall portion 33 are sequentially arranged in this order from the side of the axial second direction L2 so as to divide in the axial direction L the space inside the case 3, which is formed on the radially inward direction R1 side with respect to the peripheral wall portion 34. In the present embodiment, the first support wall portion 31 corresponds to the “partition wall” in the present invention.

As shown in FIG. 2, a first accommodating chamber 35 is formed between the first support wall portion 31 and the second support wall portion 32 in the case 3, and the rotating electrical machine MG is accommodated in the first accommodating chamber 35. In the present embodiment, the first clutch C1 is positioned on the radially inward direction R1 side of the rotating electrical machine MG1 so as to overlap the rotating electrical machine MG as viewed in the radial direction R. Thus, the first clutch C1 together with the rotating electrical machine MG is accommodated in the first accommodating chamber 35. A second accommodating chamber 36 is formed between the first support wall portion 31 and the third support wall portion 33 in the case 3, and the torque converter TC and the flex plate 8 are accommodated in the second accommodating chamber 36. That is, the first accommodating chamber 35 is separated from the second accommodating chamber 36 by the first support wall portion 31. The damper Dm is accommodated in a third accommodating chamber 37 that is fanned on the axial second direction L2 side with respect to the second support wall portion 32 in the case 3. The speed change mechanism TM (not shown in FIG. 2) is accommodated in a fourth accommodating chamber 38 that is formed on the axial first direction L1 side with respect to the third support wall portion 33 in the case 3. The first accommodating chamber 35, the second accommodating chamber 36, the third accommodating chamber 37, and the fourth accommodating chamber 38 are formed as spaces that are independent of each other. As used herein, the expression “spaces that are independent of each other” means that the spaces are separated from each other in an oiltight manner. This configuration is implemented by placing a sealing member in each part as appropriate.

In the present embodiment, the case 3 can be divided into a first case portion 3A and a second case portion 3B that is placed on the axial first direction L1 side with respect to the first case portion 3A. The first case portion 3A and the second case portion 3B are coupled and fixed together in a joint portion 3C by a bolt, not shown, etc. The first case portion 3A has the first support wall portion 31 and the second support wall portion 32, and the first accommodating chamber 35 is formed only by the first case portion 3A. In the present embodiment, the third accommodating chamber 37 is also formed by the first case portion 3A. The second case portion 3B has the third support wall portion 33, and the fourth accommodating chamber 38 is formed by the second case portion 3B. The first case portion 3A and the second case portion 3B together form the second accommodating chamber 36 that accommodates the torque converter TC.

The first support wall portion 31 is formed to extend in the radial direction R between the rotating electrical machine MG and the torque converter TC in the axial direction L so that the first accommodating chamber 35 accommodating the rotating electrical machine MG is separated in the axial direction L from the second accommodating chamber 36 accommodating the torque converter TC. In the present embodiment, the first support wall portion 31 is a wall portion in the shape of a disk extending in the circumferential direction in addition to the radial direction R. A first through hole 42 is formed in the central portion in the radial direction R of the first support wall portion 31 as a through hole extending through the first support wall portion 31 in the axial direction L.

The first support wall portion 31 includes a first cylindrical protruding portion 40 protruding toward the axial second direction L2 side. In the present embodiment, the first cylindrical protruding portion 40 is placed coaxially with the central axis X in the central portion in the radial direction R of the first support wall portion 31, and an inner peripheral surface 43 of the first cylindrical protruding portion 40 forms an outer edge of the first through hole 42. That is, the first cylindrical protruding portion 40 is a cylindrical portion (a boss portion) that is formed at an end on the side in the radially inward direction R1 of the first support wall portion 31, that is placed coaxially with the rotating electrical machine MG, and that protrudes in the axial direction L. The first cylindrical protruding portion 40 is placed on the radially inward direction R1 side with respect to a rotor member 21 described below so as to have a portion overlapping the rotor member 21 as viewed in the radial direction R. A cylindrical portion 9A of a joint member 9 described below is placed on the radially inward direction R1 side with respect to the first cylindrical protruding portion 40, namely in the first through hole 42. As shown in FIG. 3, the inner peripheral surface 43 of the first cylindrical protruding portion 40 is a stair-like inner peripheral surface whose diameter increases stepwise from the axial second direction L2 side toward the axial first direction L1 side. A first inner peripheral surface 43A is a portion of the inner peripheral surface 43 which has the smallest diameter, a second inner peripheral surface 43B is a portion of the inner peripheral surface 43 which has an intermediate diameter, and a third inner peripheral surface 43C is a portion of the inner peripheral surface 43 which has the largest diameter.

The first support wall portion 31 includes a second cylindrical protruding portion 41 having a larger diameter than the first cylindrical protruding portion 40. Like the first cylindrical protruding portion 40, the second cylindrical protruding portion 41 is formed so as to protrude toward the axial second direction L2 side, and is placed coaxially with the central axis X. The length by which the second cylindrical protruding portion 41 protrudes is shorter than that by which the first cylindrical protruding portion 41 protrudes. The second cylindrical protruding portion 41 has a smaller thickness in the radial direction R than the first cylindrical protruding portion 40. An inner peripheral stepped portion 41B having a surface facing toward the axial second direction L2 side (in this example, an annular surface) is formed in an inner peripheral surface 41A of the second cylindrical protruding portion 41. By using the inner peripheral stepped portion 41B as a boundary, a portion of the inner peripheral surface 41A which is located on the axial second direction L2 side with respect to the inner peripheral stepped portion 41B is a large diameter portion, and a portion of the inner peripheral surface 41A which is located on the axial first direction L1 side with respect to the inner peripheral stepped portion 41B is a small diameter portion.

As shown in FIG. 2, the second support wall portion 32 is formed on the axial second direction L2 side with respect to the rotating electrical machine MG (in this example, between the rotating electrical machine MG and the damper Dm in the axial direction L) so as to extend in the radial direction R. In the present embodiment, the second support wall portion 32 is a wall portion in the shape of a disk extending in the circumferential direction in addition to the radial direction R. A second through hole 32A is formed in the central portion in the radial direction R of the second support wall portion 32 as a through hole in the axial direction L. The input member I is inserted through the second through hole 32A. The second support wall portion 32 is shaped so as to be offset in the axial direction L so that a part of the second support wall portion 32 which is located on the radially inward direction R1 side is generally located on the axial first direction L1 side with respect to a part of the second support wall portion 32 which is located on the radially outward direction R2 side.

As shown in FIG. 2, the third support wall portion 33 is formed on the axial first direction L1 side with respect to the torque converter TC (in this example, between the torque converter TC and the speed change mechanism TM (see FIG. 1) in the axial direction L) so as to extend in the radial direction R. In the present embodiment, the third support wall portion 33 is a wall portion in the shape of a flat disk extending in the circumferential direction in addition to the radial direction R, and a third through hole 33A is formed in the central portion in the radial direction R of the third support wall portion 33 as a through hole in the axial direction L. The intermediate shaft M is inserted through the third insertion hole 33A. The third support wall portion 33 is provided with a hydraulic pump 33B, and a pump drive shaft 67 that drives the hydraulic pump 33B is drivingly coupled so as to rotate together with a pump impeller 61, described below, of the torque converter TC. Thus, the hydraulic pump 33B discharges oil according to rotation of the pump impeller 61 to generate an oil pressure for supplying oil to each part of the vehicle drive device 1. The pump drive shaft 67 is supported in the radial direction R via a ninth bearing 79 (in this example, a needle bearing) and a pump case so as to be rotatable with respect to the third support wall portion 33.

2-2. Rotating Electrical Machine

As shown in FIG. 2, the rotating electrical machine MG is placed in the first accommodating chamber 35 that is formed between the first support wall portion 31 and the second support wall portion 32 in the axial direction L. In the present embodiment, both sides in the axial direction L of the first accommodating chamber 35 are defined by the first support wall portion 31 and the second support wall portion 32, and the side in the radially outward direction R2 of the first accommodating chamber 35 is defined by the peripheral wall portion 34. Oil is supplied into the first accommodating chamber 35, and the rotating electrical machine MG is cooled by the oil. That is, oil that is used to cool the rotating electrical machine MG is present in the first accommodating chamber 35.

As shown in FIG. 2, the rotating electrical machine MG includes a stator St fixed to the case 3, and the rotor member 21. The stator St includes a coil end portion Ce on both sides thereof in the axial direction L. The rotor member 21 includes a rotor body Ro and a rotor support member 22 extending in the radially inward direction R1 from the rotor body Ro to support the rotor body Ro. The rotor body Ro is placed on the radially inward direction R1 side with respect to the stator St, and is supported via a rotor support member 22, which rotates together with the rotor body Ro, so as to be rotatable with respect to the case 3.

As shown in FIG. 3, the rotor support member 22 is a member that supports the rotor body Ro from the radially inward direction R1 side. In the present embodiment, the rotor support member 22 includes a rotor holding portion 25 that holds the rotor body Ro, and a radially extending portion 26. The rotor holding portion 25 is formed in a cylindrical shape that is placed coaxially with the central axis X, and that has a cylindrical portion in contact with the inner peripheral surface of the rotor body Ro, and a flange portion in contact with an end face on the side in the axial second direction L2 of the rotor body Ro. The radially extending portion 26 is formed integrally with the rotor holding portion 25, and is formed so as to extend in the radially inward direction R1 from a part of the rotor holding portion 25 which is located on the axial first direction L1 side with respect to the central part in the axial direction L1 of the rotor holding portion 25. The radially extending portion 26 is an annular plate-like portion extending in the circumferential direction in addition to the radial direction R. In the present embodiment, the radially extending portion 26 is formed so as to extend parallel to the radial direction R and so that its end on the side in the radially inward direction R1 is located on the radially outward direction R2 side with respect to the outer peripheral surface of the first cylindrical protruding portion 40. In the present embodiment, a first sleeve member 101 is placed in a gap in the radial direction R between the end on the side in the radially inward direction R1 of the radially extending portion 26 (in this example, the inner peripheral surface of a second axially protruding portion 24 described below) and the outer peripheral surface of the first cylindrical protruding portion 40. The first sleeve member 101 is provided in order to restrict the flow of oil in the gap in the axial direction L.

The radially extending portion 26 includes a first axially protruding portion 23 as a cylindrical protruding portion protruding toward the axial first direction L1 side. The first axially protruding portion 23 is placed coaxially with the central axis X, and in the present embodiment, is formed integrally with the radially extending portion 26 at the end on the side in the radially inward direction R1 of the radially extending portion 26. The first axially protruding portion 23 is positioned between the first cylindrical protruding portion 40 and the second cylindrical protruding portion 41 in the radial direction R so as to have a portion overlapping the second cylindrical protruding portion 41 as viewed in the radial direction R. A fifth bearing 75 that supports the rotor member 21 on the case 3 is placed between the outer peripheral surface of the first axially protruding portion 23 and the inner peripheral surface 41A of the second cylindrical protruding portion 41. The radially extending portion 26 includes the second axially protruding portion 24 as a cylindrical protruding portion that protrudes toward the axial second direction L2 side. The second axially protruding portion 24 is placed coaxially with the central axis X, and in the present embodiment, is formed integrally with the radially extending portion 26 at the end on the side in the radially inward direction R1 of the radially extending portion 26. A tip end 24A on the axial second direction L2 side of the second axially protruding portion 24 is located on the axial second direction L2 side with respect to a tip end 40A of the first cylindrical protruding portion 40.

A plate-like member 27 is attached to the rotor support member 22. The plate-like member 27 is an annular plate-like member extending in the circumferential direction in addition to the radial direction R. In the present embodiment, as shown in FIG. 3, the outer peripheral surface of the plate-like member 27 is provided so as to fit (in this example, spline fit) in the inner peripheral surface of a part of the rotor holding portion 25 which is located on the axial second direction L2 side with respect to the central part of the rotor holding portion 25 in the axial direction L. Thus, the plate-like member 27 rotates together with the rotor support member 22. A space is formed on the radially inward direction R1 side of the rotor holding portion 25. The side in the radially outward direction R2 of the space is defined by the rotor holding portion 25, and both sides in the axial direction L of the space are defined by the radially extending portion 26 and the plate-like member 27. This space is a space separated in an oiltight manner by a sealing member etc. placed in each part as appropriate. A hydraulic oil pressure chamber H1 and a circulating oil pressure chamber H2 of the first clutch C1, described below, are formed in this space.

In the present embodiment, the plate-like member 27 is shaped so as to be offset in the axial direction L so that a part of the plate-like member 27 which is located on the radially inward direction R1 side is generally located on the axial second direction L2 side with respect to a part of the plate-like member 27 which is located on the radially outward direction R2 side. A thick portion 28 is formed at an end on the side in the radially inward direction R1 of the plate-like member 27 so that the thick portion 28 has a larger thickness in the axial direction L than a portion on the side in the radially outward direction R2 of the plate-like member 27. A seventh bearing 77 that supports the rotor member 21 on the case 3 is placed between the outer peripheral surface of the thick portion 28 and the inner peripheral surface of an end on the side in the radially inward direction R1 of the second support wall portion 32.

2-3. First Clutch

The first clutch C1 is a device that is provided in the power transmission path between the input member I and the rotor member 21 and that is capable of changing the state of engagement. That is, the first clutch C1 is capable of switching the state of engagement between two engagement members that are engaged by the first clutch C1 between a state in which the two engagement members are engaged (including a slip-engaged state) and a state in which the two engagement members are not engaged (a disengaged state). In the state in which the two engagement members are engaged, a driving force is transmitted between the input member I and the rotor member 21. The transmission of the driving force between the input member I and the rotor member 21 is cut off in the state in which the two engagement members are disengaged.

As shown in FIG. 3, the first clutch C1 is placed between the radially extending portion 26 and the plate-like member 27 in the axial direction L. That is, the first clutch C1 is placed in the oiltight space in which the side in the radially outward direction R2 is defined by the rotor holding portion 25 and both sides in the axial direction L are defined by the radially extending portion 26 and the plate-like member 27. The first clutch C1 is positioned on the radially inward direction R1 side with respect to the roller body Ro so as to have a portion overlapping the rotor body Ro as viewed in the radial direction R. In the present embodiment, the first clutch C1 is placed at a position in the axial direction so as to overlap a central region in the axial direction L of the rotor body Ro as viewed in the radial direction R.

In the present embodiment, the first clutch C1 includes a clutch hub 51, friction members 53, and a piston 54, and is configured as a wet multi-plate clutch mechanism. In the present embodiment, the rotor holding portion 25 of the rotor support member 22 functions as a clutch drum. The first clutch C1 has a pair of input-side and output-side friction members as the friction members 53. The input-side friction member is supported by an outer peripheral portion of the clutch hub 51 from the radially inward direction R1 side, and the output-side friction member is supported by an inner peripheral portion of the rotor holding portion 25 from the radially outward direction R2 side. The clutch hub 51 other than the portion of the clutch hub 51 which holds the friction members 53 is an annular plate-like portion extending in the radial direction R and the circumferential direction. An end on the side in the radially inward direction R1 of the clutch hub 51 is coupled (in this example, bonded by welding) to a flange portion IA of the input member I.

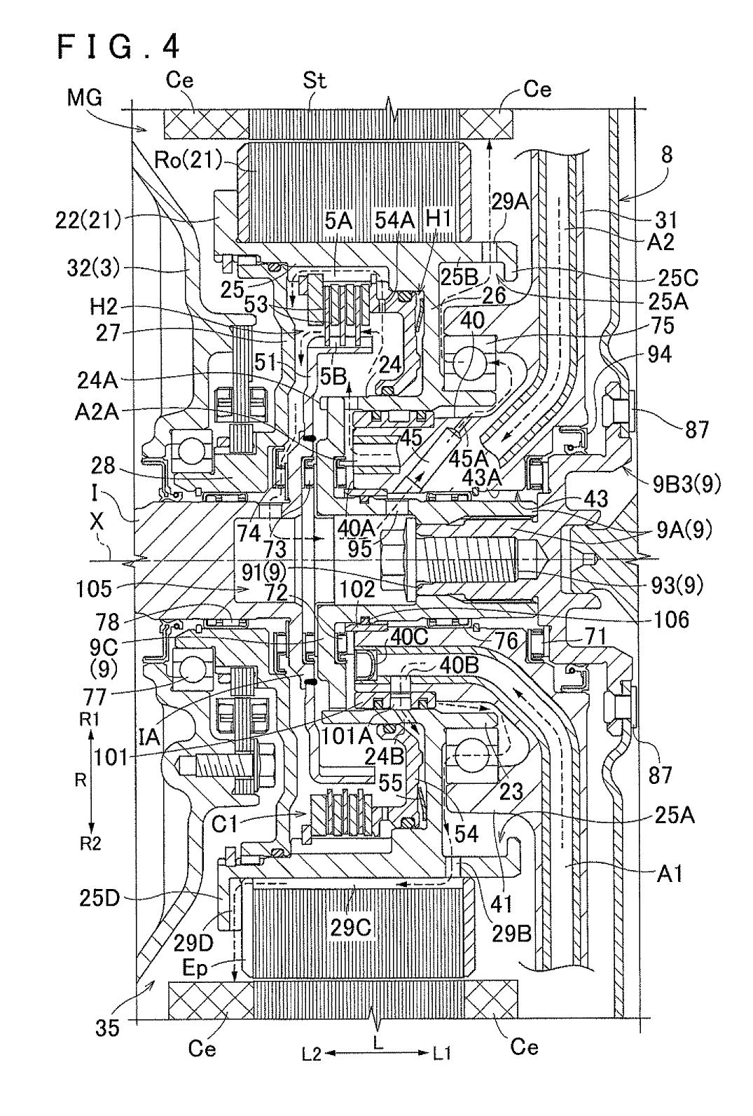

As shown in FIG. 4, the hydraulic oil pressure chamber H1 of the first clutch C1 is surrounded by the radially extending portion 26 and the second axially protruding portion 24 of the rotor support member 22 and the piston 54. The circulating oil pressure chamber H2 of the first clutch C1 is mainly surrounded by the rotor holding portion 25 (the clutch drum) of the rotor support member 22, the plate-like member 27 attached to the rotor support member 22, the piston 54, etc., and the clutch hub 51 and the friction members 53 are accommodated in the circulating oil pressure chamber H2. The hydraulic oil pressure chamber H1 and the circulating oil pressure chamber H2 are placed on both sides in the axial direction L of the piston 54, and are separated from each other in an oiltight manner by a sealing member. In the present embodiment, both the hydraulic oil pressure chamber H1 and the circulating oil pressure chamber H2 are positioned on the radially inward direction R1 side with respect to the rotor body Ro so as to overlap the rotor body Ro along its entire length in the axial direction L as viewed in the radial direction R.

A biasing member 55 presses the piston 54 to the friction members 53 side in the axial direction L (in this example, the axial second direction L2 side). Thus, the first clutch C1 is engaged or disengaged according to the balance between the pressing force of the piston 54 in the axial second direction L2 due to the oil pressure in the hydraulic oil pressure chamber H1 and the biasing member 55 and the pressing force of the piston 54 in the axial first direction L1 due to the oil pressure in the circulating oil pressure chamber H2. That is, in the present embodiment, the state of engagement of the first clutch C1 can be controlled by sliding the piston 54 in the axial direction L according to the difference in oil pressure (the differential pressure) between the hydraulic oil pressure chamber H1 and the circulating oil pressure chamber H2. As described below, the circulating oil pressure chamber H2 is basically filled with oil of a predetermined pressure or more during running of the vehicle, and the friction members 53 are cooled by this oil.

2-4. Torque Converter

As shown in FIG. 2, the torque converter TC is placed on the axial first direction L1 side with respect to the rotating electrical machine MG and coaxially with the rotating electrical machine MG. The torque converter TC is placed between the first support wall portion 31 and the third support wall portion 33 in the axial direction L. The torque converter TC includes a rotary housing 60, the pump impeller 61, a turbine runner 62, and a second clutch C2 as a lockup clutch.

The rotary housing 60 is coupled so as to rotate together with the pump impeller 61 placed inside the rotary housing 60. The rotary housing 60 is coupled so that the pump drive shaft 67 rotates together with the rotary housing 60 as described above. In the present embodiment, a coupling input member as an input member of the torque converter TC (the fluid coupling) is formed the pump impeller 61, the rotary housing 60, and the pump drive shaft 67. As described in detail below, in the present embodiment, the rotary housing 60 is drivingly coupled to the rotor member 21 via the flex plate 8 and the joint member 9.

The turbine runner 62 is drivingly coupled to the intermediate shaft M. A coupling output member as an output member of the torque converter TC (the fluid coupling) is formed by the turbine runner 62. As shown in FIG. 1, the turbine runner 62 is drivingly coupled to the wheels W via the intermediate shaft M, the speed change mechanism TM, the output member O, and the output differential gear unit DF. In the present embodiment, the turbine runner 62 and the intermediate shaft M are drivingly coupled together by spline fitting so as to be relatively movable in the axial direction L and so as to rotate together with a certain amount of backlash (play) in the circumferential direction.

As shown in FIG. 3, the rotary housing 60 is a housing that accommodates the pump impeller 61 and the turbine runner 62, which serve as a main body of the torque converter TC, and the second clutch C2. A surface of the rotary housing 60 which faces toward the axial second direction L2 side is an opposing surface portion 63 that faces the flex plate 8 described below. The opposing surface portion 63 includes a radially outer portion 63A, a radially inner portion 63B located on the radially inward direction R1 side with respect to the radially outer portion 63A and on the rotating electrical machine MG side in the axial direction L (on the axial second direction L2 side) with respect to the radially outer portion 63A, and a stepped portion 63C connecting the radially outer portion 63A and the radially inner portion 63B in the axial direction L at a position between the radially outer portion 63A and the radially inner portion 63B in the radial direction R. The opposing surface portion 63 is a part of the rotary housing 60 which covers the surface on the axial second direction L2 side of the torque converter TC. The opposing surface portion 63 is separated from the first support wall portion 31 so that a gap in the axial direction L is formed between the opposing surface portion 63 and the first support wall portion 31. The flex plate 8 described below is placed between the opposing surface portion 63 and the first support wall portion 31 in the axial direction L.

The radially outer portion 63A is a part of the opposing surface portion 63 which is located on the radially outward direction R2 side, and is an annular plate-like portion formed so as to extend in the radial direction R and the circumferential direction. In the present embodiment, the radially outer portion 63A extends parallel to the radial direction R, an end on the side in the radially outward direction R2 of the radially outer portion 63A is connected to an outer peripheral wall surface portion 64 of the rotary housing 60, and an end on the side in the radially inward direction R1 of the radially outer portion 63A is connected to the stepped portion 63C. The radially inner portion 63B is a part of the opposing surface portion 63 which is located on the radially inward direction R1 side, and is an annular plate-like portion formed so as to extend in the radial direction R and the circumferential direction. In the present embodiment, the radially inner portion 63B extends parallel to the radial direction R, and an end on the side in the radially outward direction R2 of the radially inner portion 63B is connected to the stepped portion 63C. The radially inner portion 63B is placed so as to protrude in the axial second direction L2 with respect to the radially outer portion 63A, and the stepped portion 63C having a cylindrical shape is formed so as to connect the end on the side in the radially outward direction R2 of the radially inner portion 63B to the end on the side in the radially inward direction R1 of the radially outer portion 63A. An end on the side in the axial first direction L1 of the stepped portion 63C is connected to the radially outer portion 63A, and an end on the side in the axial second direction L2 of the stepped portion 63C is connected to the radially inner portion 6311. A central protruding portion 63D is formed near a central axis portion of the radially inner portion 63B. The central protruding portion 63D is a cylindrical protruding portion that is placed coaxially with the central axis X and that protrudes in the axial second direction L2 from the radially inner portion 63B. Since the radially inner portion 63B is placed on the axial second direction L2 side with respect to the radially outer portion 63A, a space is formed in the rotary housing 60 on the radially inward direction R1 side with respect to the stepped portion 63C. The second clutch C2 is placed in this space. In this example, the second clutch C2 is positioned in the space located on the radially inward direction R1 side with respect to the stepped portion 63C so that the second clutch C2 has a portion overlapping the stepped portion 63C as viewed in the radial direction R.

The torque converter TC includes a coupling-side joint portion 65 to which an outer periphery-side fixing portion 82 of the flex plate 8 is fixed. The coupling-side joint portion 65 is positioned so as to have a portion overlapping the rotary housing 60 as viewed in the axial direction R, and is fixed to the rotary housing 60. The coupling-side joint portion 65 is positioned so as to have a portion overlapping the stepped portion 63C as viewed in the radial direction L, and is fixed to the radially outer portion 63A. The coupling-side joint portion 65 includes a joint contact surface 65A that is contacted by the outer periphery-side fixing portion 82 of the flex plate 8. The coupling-side joint portion 65 is fixed with a contact surface of the outer periphery-side fixing portion 82 being in contact with the joint contact surface 65A. In the present embodiment, the coupling-side joint portion 65 is fixed to the outer periphery-side fixing portion 82 by a fastening bolt 85 that extends through the outer periphery-side fixing portion 82 in a fastening direction Y from the radially outward direction R2 side. The fastening direction Y is a direction perpendicular to the joint contact surface 65A. A structure of fixing the coupling-side joint portion 65 to the flex plate 8 will be described in detail later.

2-5. Joint Structure of Rotating Electrical Machine and Torque Converter

The rotating electrical machine MG is coupled to the torque converter TC via the joint member 9 and the flex plate 8. More specifically, the rotor member 21 of the rotating electrical machine MG is coupled to the rotary housing 60 of the torque converter TC via the joint member 9 and the flex plate 8. In other words, the rotor member 21 is coupled to the rotary housing 60 via the flex plate 8, and the rotor member 21 is coupled to the flex plate 8 via the joint member 9. The joint member 9 and the flex plate 8 serve as a member that couples the rotor member 21 to the rotary housing 60 so that the rotor member 21 rotates interlocking with the rotary housing 60.

The joint member 9 includes the cylindrical portion 9A formed in a cylindrical shape, a first flange portion 9B which extends in the radially outward direction R2 from the cylindrical portion 9A and to which an inner periphery-side fixing portion 83 of the flex plate 8 is fixed, and a second flange portion 9C which extends in the radially outward direction R2 from the cylindrical portion 9A in the second accommodating chamber 36 and to which the rotor member 21 is coupled. The cylindrical portion 9A is placed coaxially with the central axis X, and is formed so as to extend on the radially inward direction R1 side with respect to the first cylindrical protruding portion 40, and to extend in the axial direction L. The first flange portion 9B is coupled to an end on the side in the axial first direction L1 of the cylindrical portion 9A, and the second flange portion 9C is coupled to an end on the side in the axial second direction L2 of the cylindrical portion 9A. In the present embodiment, the joint member 9 is formed by two members, namely a first joint member 91 and a second joint member 92. The first joint member 91 includes the first flange portion 9B, and the second joint member 92 includes the second flange 9C. The cylindrical portion 9A is configured by coupling both a first cylindrical portion 91A of the first joint member 91 and a second cylindrical portion 92A of the second joint member 92.

The first joint member 91 includes the first cylindrical portion 91A and the first flange portion 9B. The first cylindrical portion 91A is formed in a cylindrical shape. The first cylindrical portion 91A is placed coaxially with the central axis X on the radially inward direction R1 side with respect to the second cylindrical protruding portion 92A of the second joint member 92 described below. The inner peripheral surface of the first cylindrical portion 91A is internally threaded so that a bolt as a fastening member 93 is fastened therein. Spline teeth and a contact surface are formed in the outer peripheral surface of the first cylindrical portion 91A. The contact surface is a smooth cylindrical surface that is formed on the axial second direction L2 side with respect to the spline teeth, and that has a diameter equal to or less than that of the root surface of the spline teeth. The first cylindrical portion 91A is coupled to the second cylindrical portion 92A by engagement of the spline teeth of the first cylindrical portion 91A with the spline teeth of the second cylindrical portion 92A. At this time, the contact surface of the first cylindrical portion 91A contacts that of the second cylindrical portion 92A, whereby the positional relation between the first cylindrical portion 91A and the second cylindrical portion 92A in the radial direction R is restricted, and the first cylindrical portion 91A and the second cylindrical portion 92A are positioned coaxially with the central axis X.

The first flange portion 9B is an annular plate-like portion that extends in the radially outward direction R2 from an end in the axial first direction L1 of the first cylindrical portion 91A, and that also extends in the circumferential direction. In this example, the first flange portion 9B is formed in the shape of a stepped annular plate having a stair-like section that is stepped in the axial first direction L1 as the position in the first flange portion 9B is closer to the radially outward direction R2 side. Thus, the first flange portion 9B includes an inner flange portion 9B1 as a first annular plate-like portion extending from the first cylindrical portion 91A in the radially outward direction R2, a flange stepped portion 9B2 as a cylindrical portion extending in the axial first direction L1 from an end on the side in the radially outward direction R2 of the inner flange portion 9B1, and an outer flange portion 9B3 as a second annular plate-like portion extending in the radially outward direction R2 from an end on the side in the axial first direction L1 of the flange stepped portion 9B2. Thus, the outer flange portion 9B3 is located on the radially outward direction R2 side and the axial first direction L1 side with respect to the inner flange portion 9B1. The outer flange portion 9B3 is placed on the torque converter TC side (the axial first direction L1 side) with respect to the first support wall portion 31. In the present embodiment, the outer flange portion 9B3 of the first flange portion 9B corresponds to the “flange portion” in the present invention.

The flex plate 8 is fixed to the outer flange portion 9B3 of the first flange portion 9B. Specifically, the inner periphery-side fixing portion 83 of the flex plate 8 is fixed to the outer flange portion 9B3. In the present embodiment, the inner periphery-side fixing portion 83 is fixed to the outer flange portion 9B3 by a rivet 87 that extends through the inner periphery-side fixing portion 83 in a direction parallel to the axis direction L. A through hole 9B3A and an inner peripheral stepped portion 9B3B are formed in the outer flange portion 9B3 in order to fix and position the inner periphery-side fixing portion 83. The through hole 9B3A is a hole that allows the rivet 87 to extend therethrough, and the through hole 9B3A extends through the outer flange portion 9B3 in the axial direction L. The inner peripheral stepped portion 9B3B is a stepped portion formed in order to position the inner periphery-side fixing portion 83 of the flex plate 8. The outer peripheral surface of the inner peripheral stepped portion 9B3B contacts the inner peripheral surface of the inner periphery-side fixing portion 83 (the inner peripheral surface of a central axis opening 84), whereby the inner periphery-side fixing portion 83 is positioned coaxially with the central axis X.

In the present embodiment, a sealing member 94 is provided between the first support wall portion 31 and the outer peripheral surface of the first joint member 91 (the joint member 9) which is located on the rotating electrical machine MG side (the axial second direction L2 side) with respect to the outer flange portion 9B3. Specifically, the sealing member 94 is placed between the outer peripheral surface of the flange stepped portion 9B2 in the first flange portion 9B and the third inner peripheral surface 43C of the first cylindrical protruding portion 40 as the inner peripheral surface of the first support wall portion 31 which faces the outer peripheral surface of the flange stepped portion 9B2. This configuration allows the sealing member 94 to be placed by effectively using the space between the joint member 9 and the first support wall portion 31. The sealing member 94 allows the rotating electrical machine MG to be coupled to the torque converter TC via the joint member 9 and the flex plate 8, and can ensure the hermetic seal property between the first accommodating chamber 35 accommodating the rotating electrical machine MG and the second accommodating chamber 36 accommodating the torque converter TC. Thus, the second accommodating chamber 36 is separated in an airtight state so as not to allow oil to enter the first accommodating chamber 35. This can suppress entrance of the oil, which is present in the first accommodating chamber 35 in order to cool the rotating electrical machine, etc., into the second accommodating chamber 36

Moreover, in the configuration of the present embodiment, a first bearing 71 is placed between a surface of the first joint member 91 (the joint member 9) and a surface of the first support wall portion 31 which face each other in the axial direction L. Specifically, the first bearing 71 is placed between the inner flange portion 9B1 and the surface of the first support wall portion 31 which faces the inner flange portion 9B1. The first bearing 71 is a bearing that supports the first joint member 91 (the joint member 9) from the axial second direction L2 side so that the first joint member 91 (the joint member 9) is rotatable with respect to the first support wall portion 31. A bearing capable of receiving load in the axial direction L (in this example, a thrust bearing) is used as the first bearing 71. The surface of the inner flange portion 9B1 which faces the first support wall portion 31 is the surface of the inner flange portion 9B1 which faces toward the axial second direction L2 side. The surface of the first support wall portion 31 which faces the inner flange portion 9B1 is the surface of the stepped portion of the first inner peripheral surface 43A and the second inner peripheral surface 43B in the first cylindrical protruding portion 40, which faces toward the axial first direction L1 side. The first flange portion 9B has a cylindrical protruding portion 9B4 that is placed coaxially with the central axis X and that protrudes in the axial first direction L1 from the inner flange portion 9B1. The central protruding portion 63D is loosely fitted in the cylindrical protruding portion 9B4 with the outer peripheral surface of the central protruding portion 63D being in contact with the inner peripheral surface of the cylindrical protruding portion 9B4. Thus, the central protruding portion 63D is supported in the radial direction R so as to be placed coaxially with the central axis X.

The second joint member 92 includes the second cylindrical portion 92A and the second flange portion 9C. The second cylindrical portion 92A is formed in a cylindrical shape, and is placed coaxially with the central axis X on the radially outward direction R2 side with respect to the first cylindrical portion 91A of the first joint member 91. Spline teeth and a contact surface are formed in the inner peripheral surface of the second cylindrical portion 92A. The contact surface is a smooth cylindrical surface that is formed on the axial second direction L2 side with respect to the spline teeth, and that has a diameter equal to or less than that of the root surface of the spline teeth. The second cylindrical portion 92A is coupled to the first cylindrical portion 91A by engagement of the spline teeth of the second cylindrical portion 92A with the spline teeth of the first cylindrical portion 91A. At this time, the contact surface of the second cylindrical portion 92A contacts that of the first cylindrical portion 92A, whereby the positional relation between the second cylindrical portion 92A and the first cylindrical portion 91A in the radial direction R is restricted, and the second cylindrical portion 92A and the first cylindrical portion 91A are positioned coaxially with the central axis X. A sixth bearing 76 and a second sleeve member 102 are placed between the outer peripheral surface of the first cylindrical portion 91A and the first inner peripheral surface 43A of the first cylindrical protruding portion 40. The second sleeve member 102 is placed on the axial second direction L2 side with respect to the sixth bearing 76. In this example, the second sleeve member 102 is positioned so as to overlap the tip end 40A of the first cylindrical protruding portion 40 as viewed in the radial direction R. The second sleeve member 102 is provided in order to restrict the flow of oil in the axial direction L in a gap between the outer peripheral surface of the first cylindrical portion 91A and the inner peripheral surface 43A of the first cylindrical protruding portion 40.

The second cylindrical portion 92A is placed on the radially inward direction R1 side with respect to the first cylindrical protruding portion 40, and is formed so as to extend further in the axial second direction L2 than the tip end 40A of the first cylindrical protruding portion 40. The second flange portion 9C is formed so as to extend in the radially outward direction R2 from an end on the side in the axial second direction L2 of the second cylindrical portion 92A. Thus, the second flange portion 9C is placed on the side of the axial second direction L2 with respect to the first cylindrical protruding portion 40. The second flange portion 9C is an annular plate-like portion extending in the radially outward direction R2 from an end in the axial second direction L2 of the second cylindrical portion 92A, and also extending in the circumferential direction. In the configuration of the present embodiment, a second bearing 72 is placed between a surface of the second joint member 92 (the joint member 9) and a surface of the first cylindrical protruding portion 40 which face each other in the axial direction L. Specifically, the second bearing 72 is placed between the second flange portion 9C and the tip end 40A of the first cylindrical protruding portion 40 which faces the second flange portion 9C. The second bearing 72 is a bearing that supports the second joint member 92 (the joint member 9) from the axial first direction L1 side so that the second joint member 92 (the joint member 9) is rotatable with respect to the first support wall portion 31 (the first cylindrical protruding portion 40). A bearing capable of receiving load in the axial direction L (in this example, a thrust bearing) is used as the second bearing 72.

The second flange portion 9C is coupled to the rotor support member 22 at a position on the radially outward direction R2 side with respect to the first cylindrical protruding portion 40. In the present embodiment, an end on the side in the radially outward direction R2 of the second flange portion 9C and the tip end 24A (an end on the side in the axial second direction L2) of the second axially protruding portion 24 of the rotor support member 22 are coupled to (engaged with) each other so as to rotate together and to be relatively movable in the axial direction L. Specifically, the end on the side in the radially outward direction R2 of the second flange portion 9C is an external tooth engagement portion in which a plurality of engagement pieces protruding in the radially outward direction R2 are dispersed and arranged in the circumferential direction. The tip end 24A of the second axially protruding portion 24 is a cylindrical engagement portion in which a plurality of through holes (the same number of through holes as the engagement pieces) are dispersed and arranged in the circumferential direction. The width in the circumferential direction and the length in the axial direction L of the through holes are large enough to allow the engagement pieces to be inserted therein. In this example, the through holes are through holes which have a U-shape as viewed in the radial direction R, which open in an edge on the side in the axial second direction L2 of the second axially protruding portion 24, and whose length in the axial direction L is larger than the length in the axial direction L of the engagement pieces. In such a spline-like engagement mechanism, the second axially protruding portion 24 and the second flange portion 9C are coupled together so as to rotate together and to be relatively movable in the axial direction L. As a result, the rotor member 21 and the second flange portion 9C, namely the rotor member 21 and the joint member 9, are drivingly coupled together so as to be relatively movable in the axial direction L.

As described above, the first joint member 91 is coupled to the second joint member 92 by spline coupling using the spline teeth extending in the axial direction L. Thus, relative movement in the axial direction L between the first joint member 91 and the second joint member 92 is not restricted by this spline coupling. In the present embodiment, a movement restricting mechanism is provided which restricts relative movement in the axial direction L between the first joint member 91 and the second joint member 92. In this example, an end face on the side in the axial first direction L1 of the second cylindrical portion 92A contacts a surface on the side in the axial second direction L2 of the inner flange portion 9B1 of the first flange portion 9B, and a surface of the bolt as the fastening member 93, which faces toward the axial first direction L1 side in the state where the fastening member 93 is fastened and fixed in the internally threaded portion formed in the inner peripheral surface of the first cylindrical portion 91A, contacts a surface of the second cylindrical portion 92A which faces toward the axial second direction L2 side, thereby forming the movement restricting mechanism. Specifically, an inner peripheral stepped portion 92A1 having a surface facing toward the axial second direction L2 (in this example, an annular surface) is formed in the inner peripheral surface of the second cylindrical portion 92A. The fastening member 93 (in this example, the bolt) has an annular portion 93A (in this example, a head portion of a flanged bolt) that protrudes toward the radially outward direction R2 side from the outer peripheral surface of the first cylindrical portion 91A in the state where the fastening member 93 is fastened and fixed in the internally threaded portion of the first cylindrical portion 91A. The annular portion 93A contacts the surface of the inner peripheral stepped portion 92A1 which faces toward the axial second direction L2 side, whereby relative movement in the axial direction L between the first joint member 91 and the second joint member 92 is restricted.

As shown in FIGS. 2 and 3, the flex plate 8 is a disk-like member placed coaxially with the central axis X (coaxially with the rotating electrical machine MG). In this example, the flex plate 8 is formed in the shape of an annular plate shape including the central axis opening 84 formed in a central portion in the radial direction R of the flex plate 8 so as to extend through the flex plate 8 in the axial direction L. In the present embodiment, the flex plate 8 corresponds to the “disk-like member” in the present invention. As shown in FIG. 3, the flex plate 8 includes a disk-like main body 81, the outer periphery-side fixing portion 82, and the inner periphery-side fixing portion 83, in addition to the central axis opening 84.

The disk-like main body 81 is formed in the shape of a disk shape that is placed between the rotating electrical machine MG and the torque converter TC in the axial direction L, specifically between the first support wall portion 31 and the torque converter TC in the axial direction L, and that extends in the radial direction R. In the present embodiment, the outer periphery-side fixing portion 82 is provided continuously with the side in the radially outward direction R2 of the disk-like main body 81, and the inner periphery-side fixing portion 83 is provided continuously with the side in the radially inward direction R1 of the disk main body 81. Thus, the disk-like main body 81 is an annular plate-like region of an intermediate portion in the radial direction R interposed between the outer periphery-side fixing portion 82 and the inner periphery-side fixing portion 83 in the flex plate 8. In this example, the disk-like main body 81 includes an annular raised portion 81A on the side in the radially outward direction R2 with respect to the boundary with the inner periphery-side fixing portion 83. The annular raised portion 81A is a portion that is raised toward the axial second direction L2 side with respect to the remaining portion of the disk-shaped main body 81, and that has an arc-shaped cross section. Since the annular raised portion 81A is continuously formed in the entire region in the circumference direction, the annular raised portion 81A is a generally annular raised portion. In the present embodiment, the entire disk-like main body 81 other than the annular raised portion 81A is in the shape of a simple flat plate placed parallel to the radial direction R.

The inner periphery-side fixing portion 83 is a part of the flex plate 8 and is formed integrally on the side of the radially inward direction R1 with respect to the disk-like main body 81. In the present embodiment, the central axis opening 84 extending through the flex plate 8 in the axial direction L is provided in the central portion in the radial direction R of the flex plate 8, which is located on the side of the radially inward direction R1 with respect to the disk-like main body 81. Thus, the inner periphery-side fixing portion 83 is formed in the shape of an annular plate having a constant radial width, and the inner peripheral surface of the central axis opening 84 serves as the inner peripheral surface of the inner periphery-side fixing portion 83. The inner periphery-side fixing portion 83 is fixed to the joint member 9 by the rivet 87 extending through the inner periphery-side fixing portion 83 in a direction parallel to the axial direction L. In the present embodiment, the diameter of the central axis through hole 84 is the same as the outer diameter of the inner peripheral stepped portion 9B3B of the outer flange portion 9B3. The inner peripheral surface of the central axis opening 84 is fitted on the outer peripheral surface of the inner peripheral stepped portion 9B3B so as to contact the outer peripheral surface of the inner peripheral stepped portion 9B3B, whereby the inner periphery-side fixing portion 83 is positioned coaxially with the central axis X. The inner periphery-side fixing portion 83 includes an inner periphery-side through hole 83A as a through hole extending through the inner periphery-side fixing portion 83 in the axial direction L. The inner periphery-side through hole 83A is positioned so as to overlap the through hole 9B3A of the outer flange portion 9B3 in the state where the central axis opening 84 is fitted on the inner peripheral stepped portion 9B3B of the outer flange portion 9B3. The rivet 87 is inserted through both the central axis opening 84 and the through hole 9B3A along a direction parallel to the axial direction L, and one end of the rivet 87 is deformed, whereby the inner periphery-side fixing portion 83 is fixed to the outer flange portion 9B3 of the first flange portion 9B. Such a fixing structure using the rivet 87 eliminates the need to internally thread the outer flange portion 9B3, as compared to fixing using a bolt, and also can reduce the amount by which the head portion protrudes, as compared to the bolt. Thus, the axial dimension of the fixed portion of the inner periphery-side fixing portion 83 and the joint member 9 can be reduced. As can be seen from FIG. 3, the space in the axial direction L is smaller on the side in the radially inward direction R1 of the flex plate 8 than on the side in the radially outward direction R2 of the flex plate 8. Thus, such a configuration using the rivet 87 is particularly effective in reducing the axial direction of the vehicle drive device 1.

The outer periphery-side fixing portion 82 is a part of the flex plate 8 and is formed integrally on the side in the radially outward direction R2 of the disk-like main body 81. The outer peripheral-side fixing portion 82 is formed along a surface tilted with respect to the disk-like main body 81, and specifically, is formed in the shape of a truncated conical surface tilted with respect to the radially outward direction R2 so that the diameter increases from the rotating electrical machine MG side (the axial second direction L2 side) to the torque converter TC side (the axial first direction L1 side) in the axial direction L. In other words, the outer periphery-side fixing portion 82 is shaped so as to extend along an imaginary conical surface tilted with respect to the radially outward direction R2 so that the diameter increases from the axial second direction R2 side toward the axial first direction L1 side. In the present embodiment, the outer periphery-side fixing portion 82 is bent so that a part of the flex plate 8 which is located on the radially outward direction R2 side with respect to the disk-shaped main body 81 is tilted to one side in the axial direction L (the axial first direction L1 side in the assembled state of the vehicle drive device 1). Thus, the outer periphery-side portion 82 is a part of the flex plate 8, which is located on the radially outer direction R2 side with respect to a bent portion 82B as the boundary with the disk-like main body 81, and which forms a truncated conical surface parallel to an imaginary conical surface tilted with respect to the radially outward direction R2 so that the diameter increases from the rotating electrical machine MG side to the torque converter TC side in the axial direction L. A tilted surface (a radially inner surface) of the outer periphery-side fixing portion 82, which faces toward the radially inward direction R1 side and the axial first direction L1 side, serves as the contact surface that contacts the joint contact surface 65A of the coupling-side joint portion 65. In the illustrated example, an edge portion 88 that is bent in a direction from the outer periphery-side fixing portion 82 toward an inner wall surface of the case 3 is formed on the side in the radially outer direction R2 of the outer periphery-side fixing portion 82.

The coupling-side joint portion 65 as a member on the rotary housing 60 side of the torque converter TC to which the outer periphery-side fixing portion 82 is fixed will be described in detail below. As described above, the coupling-side joint portion 65 includes the joint contact surface 65A that contacts the outer periphery-side fixing portion 82. The joint contact surface 65A is formed at the same position and tilt angle as the contact surface of the outer periphery-side fixing portion 82 so as to contact the outer periphery-side fixing portion 82. That is, like the outer periphery-side fixing portion 82, the joint contact surface 65A is formed along a surface parallel to an imaginary conical surface tilted with respect to the radially outward direction R2 so that the diameter increases from the rotating electrical machine MG side to the torque converter TC side in the axial direction L. The outer periphery-side fixing portion 82 is fixed to the coupling-side joint portion 65 by the fastening bolt 85 that extends through the outer periphery-side fixing portion 82 along the fastening direction Y from the radially outer direction R2 side. The fastening direction Y is the direction perpendicular to the joint contact surface 65A. As described above, the contact surface of the outer periphery-side fixing portion 82 is formed parallel to the joint contact surface 65A of the coupling-side joint portion 65. Thus, the fastening direction Y is a direction perpendicular to both of these surfaces.

In the present embodiment, a plurality of the coupling-side joint portions 65 (e.g., 3 to 12) are dispersed and arranged in the circumferential direction of the rotary housing 60. An internally threaded portion in which the fastening bolt 85 is fastened is formed in each of the plurality of coupling-side joint portions 65. Specifically, each of the plurality of coupling-side joint portions 65 has a nut member 65B having an internally threaded portion in which the fastening bolt 85 is fastened, and a support member 65C that supports the nut member 65B so that the nut member 65B extends in the fastening direction Y. The nut member 65B is a columnar member having the internally threaded portion extending through the central part thereof. The nut member 65B is in the shape of, e.g., a hexagonal prism, a rectangular prism, etc., and a through hole formed along a central axis portion of the nut member 65B has an internally threaded inner peripheral surface. A tilted surface (a radially outer surface) of the nut member 65B which faces toward the radially outward direction R2 side and the axial second direction L2 side is the joint contact surface 65A of the coupling-side joint portion 65. In the configuration in which the plurality of coupling-side joint portions 65 are dispersed and arranged as in the present embodiment, the area of the joint contact surface 65A of each coupling-side joint portion 65 is limited to a small area. Thus, the joint contact surface 65A of each coupling-side joint portion 65 need not necessarily be a curved surface along the imaginary conical surface parallel to the outer periphery-side fixing portion 82, and may be a simple flat surface. The support member 65C is a member that fixes and supports the nut member 658 on the rotary housing 60, and for example, is bonded to the nut member 65B and the rotary housing 60 by welding etc. The support member 65C supports the nut member 65B so that the central axis of the internally threaded portion of the nut member 65B (the central axis of the nut member 65B) extends parallel to the fastening direction Y.

The outer periphery-side fixing portion 82 of the flex plate 8 is fixed in contact with the joint contact surface 65A of the coupling-side joint portion 65. Since the fixing bolt 85 is used for this fixing, an outer periphery-side through hole 82A is provided in the outer periphery-side fixing portion 82 as a through hole through which the fastening bolt 85 extends in the fastening direction Y. A plurality of the outer periphery-side through holes 82A are dispersed and arranged in the circumferential direction of the outer periphery-side fixing portion 82. In this example, the number of outer periphery-side through holes 82A is the same as the number of internally threaded portions in the coupling-side joint portions 65, and the outer periphery-side through holes 82A are positioned so as to be aligned with the internally threaded portions of the plurality of coupling-side joint portions 65. The fastening bolt 85 is inserted through the outer periphery-side fixing portion 82 in the fastening direction Y from the radially outward direction R2 side, and is screwed in the internally threaded portion in the nut member 65B, whereby the outer periphery-side fixing portion 82 is interposed between the head portion of the fastening bolt 85 and the joint contact surface 65A, and is fixed to the coupling-side joint portion 65.

The coupling-side joint portion 65 is fixed to the rotary housing 60 at a position where the coupling-side joint portion 65 has a portion overlapping the rotary housing 60 as viewed in the axial direction L. In the present embodiment, the coupling-side joint portion 65 is positioned so that the entire coupling-side joint portion 65 overlaps the rotation housing 60 as viewed in the axial direction L. That is, the coupling-side joint portion 65 is positioned on the radially inward direction R1 side with respect to the outer peripheral surface of the outer peripheral wall surface portion 64 of the rotary housing 60. The joint contact surface 65A of the coupling-side joint portion 65 is provided so as not to overlap the rotating electrical machine MG as viewed in the direction perpendicular to the joint contact surface 65A, namely in the fastening direction Y. In the present embodiment, the joint contact surface 65A is also provided so as not to overlap the first support wall portion 31 as viewed in the fastening direction Y Thus, the joint contact surface 65A is also provided so as not to overlap the first accommodating chamber 35 accommodating the rotating electrical machine MG; as viewed in the fastening direction Y. In this configuration, the rotating electrical machine MG and the first support wall portion 31 do not obstruct formation of an opening 39 described below, and the opening 39 can be easily provided in the peripheral wall portion 34 of the case 3. Accordingly, when the fastening bolt 85 is inserted via the opening 39 and the outer periphery-side fixing portion 82 is fastened and fixed to the coupling-side joint portion 65 by the fastening bolt 85, this fastening/fixing operation can be easily performed from the radially outward direction R2 side of the outer periphery-side fixing portion 82 and also from the outside of the case 3.

The opening 39 that is used to perform the operation of inserting the fastening bolt 85 and the fastening/fixing operation performed by the fastening bolt 85 is provided in the peripheral wall portion 34 of the case 3. In this example, the peripheral wall portion 34 surrounds the side in the radially outer direction R2 of the second accommodating chamber 36 accommodating the torque converter TC, the opening 39 is provided in a portion of the peripheral wall portion 34, and the portion of the peripheral wall portion 34 includes a portion that overlaps the joint contact surface 65A as viewed in the direction perpendicular to the joint contact surface 65A (the fastening direction Y). As described above, the plurality of coupling-side joint portions 65 are dispersed and arranged in the circumferential direction of the rotary housing 60. Accordingly, a portion of the peripheral wall portion 34 which overlaps the joint contact surface 65A changes according to the position of the coupling-side joint portion 65 in the rotational direction of the rotary housing 60. Thus, the opening 39 is provided in a portion that will overlap the joint contact surface 65A as viewed in the fastening direction Y, namely in a portion that overlaps the joint contact surface 65A as viewed in the fastening direction Y at any of the positions in the rotational direction when the coupling-side joint portion 65 is rotated together with the rotary housing 60.

In the present embodiment, the case 3 can be divided into the first case portion 3A and the second case portion 3B. The portion of the peripheral wall portion 34 that includes a portion that overlaps the joint contact surface 65A as viewed in the fastening direction Y is the portion of the peripheral wall portion 34 in the first case portion 3A. That is, the opening 39 is formed in a portion of the peripheral wall portion 34, namely a portion of the first case portion 3A which forms the second accommodating chamber 36. The opening 39 is positioned and sized so that the entire joint contact surface 65A can be seen through the opening 39 when viewed in the fastening direction Y from the outside of the case 3. In the present embodiment, two openings 39 are formed at two different positions in the circumferential direction in the peripheral wall portion 34 of the case 3. The openings 39 are provided in this manner in order to allow rotation of the rotary housing 60 to be restricted by a tool etc. inserted through the other opening 39 when performing the fastening operation of the fastening bolt 85 from one of the openings 39. These openings 39 are closed by a lid member 89. The lid member 89 is made of e.g., a molded body of a metal plate, and a sealing member is provided in the contact portion between the lid member 89 and the peripheral wall portion 34.

### 3. Support Structure of Each Constituent Member

The support structure of each constituent member in the vehicle drive device 1 according to the present embodiment will be described below.

3-1, Support Structure in Radial Direction

As shown in FIGS. 2 and 3, the vehicle drive device 1 includes the fifth bearing 75 and the seventh bearing 77 as bearings that support the rotor member 21 in the radial direction R. The rotor member 21 is supported in the radial direction R on both sides in the axial direction L by the fifth bearing 75 and the seventh bearing 77. The fifth bearing 75 is a bearing that supports the rotor member 21 in the radial direction R so that the rotor member 21 is rotatable with respect to the first support wall portion 31. A radial bearing (in this example, a ball bearing) capable of receiving load in the radial direction R is used as the fifth bearing 75. The seventh bearing 77 is a bearing that supports the rotor member 21 in the radial direction R so that the rotor member 21 is rotatable with respect to the second support wall portion 32. A radial bearing (in this example, a ball bearing) capable of receiving load in the radial direction R is used as the fifth bearing 75.

In the present embodiment, the fifth bearing 75 is placed so as to contact the inner peripheral surface 41A of the second cylindrical protruding portion 41 of the first support wall portion 31 and the outer peripheral surface of the first axially protruding portion 23 of the rotor support member 22. Thus, the rotor member 21 is supported by the inner peripheral surface 41A of the second cylindrical protruding portion 41 via the fifth bearing 75. The first clutch C1 is positioned so as to have a portion overlapping the fifth bearing 75 as viewed in the axial direction L. Specifically, a portion on the side in the radially outward direction R2 of the clutch hub 51 and a portion on the side in the radially inward direction R1 of the friction members 53 supported by the clutch hub 51 are placed at the same position in the radial direction R as the fifth bearing 75. In the present embodiment, the seventh bearing 77 is placed so as to contact the inner peripheral surface of the second support wall portion 32 and the outer peripheral surface of the thick portion 28 of the plate-like member 27 attached to the rotor support member 22. Thus, the rotor member 21 is supported by the second support wall portion 32 via the plate-like member 27 and the seventh bearing 77.

An eighth bearing 78 (in this example, a needle bearing) that supports the input member I in the radial direction R so that the input member I is rotatable with respect to the second support wall portion 32 is placed on the radially inward direction R1 side with respect to the seventh bearing 77. The eighth bearing 78 is placed so as to contact the outer peripheral surface of the input member I and the inner peripheral surface of the thick portion 28 of the plate-like member 27. The input member I is supported by the second support wall portion 32 via the thick portion 28 and the seventh bearing 77 in addition to the eighth bearing 78.

The vehicle drive device 1 further includes the sixth bearing 76 and a ninth bearing 79 (see FIG. 2), and the torque converter TC and the joint member 9 are supported in the radial direction R on both sides in the axial direction L by the sixth bearing 76 and the ninth bearing 79. As shown in FIG. 3, the sixth bearing 76 is a bearing that supports the joint member 9 in the radial direction R so that the joint member 9 is rotatable with respect to the first support wall portion 31. A radial bearing (in this example, a needle bearing) capable of receiving load in the radial direction R is used as the sixth bearing 76. In the present embodiment, the sixth bearing 76 is placed so as to contact the inner peripheral surface 43 of the first cylindrical protruding portion 40 and the outer peripheral surface of the second cylindrical portion 92A. Thus, the rotary housing 60 of the torque converter TC is supported by the first support wall portion 31 via the joint member 9 and the flex plate 8.

3-2. Support Structure in Axial Direction

As shown in FIGS. 2 and 3, the vehicle drive device 1 includes the first bearing 71 and the second baring 72 as bearings that support the joint member 9 in the axial direction L with respect to the first support wall portion 31. The first bearing 71 is a bearing that supports the joint member 9 from the axial second direction L2 side so that the joint member 9 is rotatable with respect to the first support wall portion 31. A bearing (in this example, a thrust bearing) capable of receiving load in the axial direction L is used as the first bearing 71. The second bearing 72 is a bearing that supports the joint member 9 from the axial first direction L1 side so that the joint member 9 is rotatable with respect to the first support wall portion 31. A bearing (in this example, a thrust bearing) capable of receiving load in the axial direction L is used as the second bearing 72. In the present embodiment, as shown in FIG. 3, the first bearing 71 supports the inner flange portion 9B1 of the first flange portion 9B from the axial second direction L2 side, and the second bearing 72 supports the second flange portion 9C from the axial first direction L1 side. Thus, the first bearing 71 is placed between the inner flange portion 9B1 and the surface of the first support wall portion 31 which faces the inner flange portion 9B1. The second bearing 72 is placed between the second flange portion 9C and the tip end 40A of the first cylindrical protruding portion 40 which faces the second flange portion 9C.

In the present embodiment, a third bearing 73 (in this example, a thrust bearing) capable of receiving load in the axial direction L is also placed between the second flange portion 9C and the flange portion IA of the input member I in the axial direction L. A fourth bearing 74 (in this example, a thrust bearing) capable of receiving load in the axial direction L is placed between the flange portion IA of the input member I and the thick portion 28 of the plate-like member 27 in the axial direction L.

### 4. Oil Flow in First Accommodating Chamber

The flow of oil in the first accommodating chamber 35 accommodating the rotating electrical machine MG in the vehicle drive device 1 according to the present embodiment will be described below with reference to FIG. 4. In the present embodiment, oil that has circulated in the circulating oil pressure chamber H2 in order to cool the friction members 53 of the first clutch C1 is also supplied to the rotating electrical machine MG to cool the rotating electrical machine MG. In the present embodiment, as shown in FIG. 2, the vehicle drive device 1 includes two hydraulic control devices, a first hydraulic control device 103 and a second hydraulic control device 104. These hydraulic control devices adjust or control the pressure of the oil supplied from the hydraulic pump 33B to supply the resultant oil pressure to each part of the vehicle drive device 1. The first hydraulic control device 103 is placed in a lower part of the fourth accommodating chamber 38 accommodating the speed change mechanism TM (see FIG. 1), and mainly controls oil pressure supply to each part of the speed change mechanism TM and the torque converter TC. The second hydraulic control device 104 is placed on the rotating electrical machine MG side (on the axial second direction L2 side) with respect to the first hydraulic control device 103, and mainly controls oil pressure supply to each part of the speed change mechanism TM and the first clutch C1. The oil pressure supply will be sequentially described below.

4-1. Oil Supply Structure to Clutch

As shown in FIG. 4, a first oil passage A1 and a second oil passage A2 are formed in the first support wall portion 31. The first oil passage A1 is an oil supply passage that communicates with the hydraulic oil pressure chamber H1 of the first clutch C1 to supply oil for operating the piston 54 to the hydraulic oil pressure chamber H1. An oil pressure controlled to operate the first clutch C1 is supplied to the first oil passage A1 by the second hydraulic control device 104 (see FIG. 2). In the present embodiment, the first oil passage A1 first extends in the first support wall portion 31 in the radially inward direction R1 and then extends in the axial second direction L2 in the first cylindrical protruding portion 40. The first oil passage A1 is closed by a closing member 40C in the tip end 40A of the first cylindrical protruding portion 40, and communicates with the hydraulic oil pressure chamber H1 via a radial communication hole 40B formed so as to extend from the first oil passage A1 in the radially outward direction R2 and to extend through the first cylindrical protruding portion 40 in the radial direction R, a radial communication hole 101A formed so as to extend through the first sleeve member 101 in the radial direction R, and a through hole 24B formed so as to extend through the second axially protruding portion 24 of the rotor support member 32 in the radial direction R.

The second oil passage A2 communicates with the circulating oil pressure chamber H2 of the first clutch C1, and supplies oil for cooling the friction members 53 to the circulating oil pressure chamber H2. In the present embodiment, the oil that has circulated in the circulating oil pressure chamber H2 is supplied to the rotating electrical machine MG to cool the rotating electrical machine MG. Thus, the second oil passage A2 is an oil supply passage that supplies oil for cooling the friction members 53 of the first clutch C1 and the rotating electrical machine MG. An oil pressure controlled (adjusted) by the second hydraulic control device 104 (see FIG. 2) for circulation in the circulating oil passage chamber H2 and for cooling of the rotating electrical machine MG2 is supplied to the second oil passage A2. In the present embodiment, the second oil passage A2 first extend in the first support wall portion 31 in the radially inward direction R1 and then extends in the axial second direction L2 in the first cylindrical protruding portion 40. The second oil passage A2 has a tip end opening A2A that opens in the tip end 40A of the first cylindrical protruding portion 40. The tip end opening A2A of the second oil passage A2 opens toward a gap formed in the axial direction L between the second flange portion 9C of the joint member 9 and the tip end 40A of the first cylindrical protruding portion 40. A gap extending through the second axially protruding portion 24 in the radial direction R is formed in a joint portion between the tip end 24A of the second axially protruding portion 24 and the second flange portion 9C of the joint member 9. The second oil passage A2 communicates with the circulating oil pressure chamber H2 via these two gaps.

In the present embodiment, the eighth bearing 78 is a bearing having a sealing function (in this example, a needle bearing having a seal ring) which is capable of ensuring a certain level of liquid-tight property. The inner peripheral surface of the first cylindrical protruding portion 40 contacts the outer peripheral surface of the cylindrical portion 9A of the joint member 9 along the entire circumference via the second sleeve member 102 and a sealing member 106. Thus, the circulating oil pressure chamber H2 is made liquid-tight. Oil is supplied from the second oil passage A2, whereby the circulating oil pressure chamber H2 is basically filled with the oil. This allows the friction members 53 of the first clutch C1 to be effectively cooled by a large amount of oil filling the circulating oil pressure chamber H2.

Specifically, as shown by broken arrows in FIG. 4, the oil supplied from the second oil passage A2 to the circulating oil pressure chamber H2 first flows on the axial first direction L1 side with respect to the clutch hub 51 and the friction members 53 in the radially outward direction R2. Then, the oil flows, while cooling the friction members 53, to the axial second direction L2 side through a gap between the plurality of friction members 53, a gap in an outer spline engagement portion 5A that is formed between the outer peripheral portions of the friction members 53 and the inner peripheral surface portion of the rotor holding portion 25 functioning as the clutch drum and that extends in the axial direction L, a gap in an inner spline engagement portion 5B that is formed between the inner peripheral portions of the friction members 53 and the outer peripheral surface portion of the clutch hub 51 and that extends in the axial direction L, etc. In the present embodiment, since the piston 54 is provided with the communication hole 54A, the oil is guided through the communication hole 54A into the gap in the outer spline engagement portion 5A. If such a communication hole 54 is not provided, only the oil that has flown to the radially outward direction R2 side through the gap between the plurality of friction members 53 flows through the gap in the outer spline engagement portion 5A in the axial direction L. On the other hand, since the communication hole 54A is provided, the gap in the outer spline engagement portion 5A can be actively used as an oil flow path, and flowability of the oil in the circulating oil pressure chamber H2 can be improved. Accordingly, the capability of cooling the friction members 53 can be improved. The communication hole 54A is formed so as to extend through the piston 54 in the radial direction R in a portion of the piston 54 which is located on the axial first direction L1 side with respect to the friction members 53. In this example, a plurality of the communication holes 54A are dispersed and placed in the circumferential direction.

The oil that has flown to the axial second direction L2 side with respect to the friction members 53 flows to the radially inward direction R1 side through the gap between the plate-like member 27 and the clutch hub 51 and the flange portion IA. Then, the oil flows through the radial communication hole 1B formed so as to extend through the input member I in the radial direction R, and flows into an internal shaft space 105 formed in the input member I and the joint member 9 (the second coupling member 92). The oil that has flown in the internal shaft space 105 is pushed out by the oil pressure supplied from the second oil passage A2, flows in a radial communication hole 95 formed so as to extend through the cylindrical portion 9A of the joint member 9 (the second cylindrical portion 92A of the second joint member 92, see FIG. 3) in the radial direction R, and in a discharge oil passage 45 that allows the inner peripheral surface 43 (the first inner peripheral surface 43A) of the first cylindrical protruding portion 40 to communicate with the outer peripheral surface thereof, and is discharged to the side of the outer peripheral surface of the first cylindrical protruding portion 40. A throttled portion 45A is formed in a portion on the side in the radially outward direction R2 of the discharge oil passage 45, namely near the outlet of the discharge oil passage 45. This throttled portion 45A is provided to maintain the state where the circulating oil pressure chamber H2 is filled with the oil. That is, the throttled portion 45A functions to restrict the amount of the oil discharged from the discharged oil passage 45 to hold a predetermined or higher oil pressure in the circulating oil pressure chamber H2, the internal shaft space 105, and the oil passages, the gaps, etc. communicating thereto, namely in a space filled with the oil, and to maintain the state where these are filled with the oil. Thus, since the space communicating with the circulating oil pressure chamber H2 is filled with oil, the first bearing 71, the second bearing 72, the third bearing 73, the fourth bearing 74, the sixth bearing 76, and the eighth bearing 78, which are placed in this space, are appropriately lubricated with the oil. Since the sealing member 94, which seals between the joint member 9 and the first support wall portion 31, is provided on the first axial direction L1 side with respect to the first bearing 71, entrance of the oil into the second accommodating chamber 36 on the torque converter TC side after lubricating the first bearing 71 can be restricted.

The oil discharged from the discharge oil passage 45 is supplied to the gap between the outer peripheral surface of the first cylindrical protruding portion 40 and the inner peripheral surface of the first axially protruding portion 23 of the rotor support member 22. Then, the oil flows in the fifth bearing 75 while lubricating the fifth bearing 75, and flows in the radially outward direction R2 through the gap between the end face on the side in the axial second direction L2 of the second cylindrical protruding portion 41 and the face on the side in the axial first direction L1 of the radially extending portion 26 of the rotor support member 22. The oil is collected by an oil collecting portion 25A formed in the inner peripheral surface of the rotor holding portion 25 on the radially outward direction R2 side with respect to the second cylindrical protruding portion 41.

4-2. Oil Supply Structure to Rotating Electrical Machine

In the present embodiment, oil collected by the oil collecting portion 25A is supplied to cool the rotating electrical machine MG. The oil collecting portion 25A is a receiving surface forming a cylindrical space that opens on the radially inward direction R1 side, and is a portion that collects the oil supplied from the radially inward direction R1 side. In the present embodiment, the oil collecting portion 25A is formed by a cylindrical collecting inner peripheral surface 25B of a part of the rotor holding portion 25 which is located on the axial first direction L1 side with respect to the radially extending portion 26, the radially extending portion 26 that extends from an end in the axial second direction L2 of the collecting inner peripheral surface 25B to the radially inward direction R1 side along the entire circumference, and an inner flange portion 25C formed so as to protrude toward the radially inward direction R1 side from an end on the side in the axial first direction L1 of the collecting inner peripheral surface 25B along the entire circumference.

The oil collected by the oil collecting portion 25A flows into a first radial oil passage 29A or a second radial oil passage 29B, which communicates with the oil collecting portion 25A and is formed so as to extend in the radially outward direction R2 from the collecting inner peripheral surface 25B, due to the centrifugal force that is generated by rotation of the rotor member 21. The oil that has flown into the first radial oil passage 29A passes through the first radial oil passage 29A toward the radially outward direction R2 side, and is supplied to the coil end portion Ce located on the side in the axial first direction L1 of the stator St. The oil that has flown into the second radial oil passage 29B passes through an axial oil passage 29C and a third radial oil passage 29D, which communicate with the second radial oil passage 29B, and is supplied to the coil end portion Ce located on the side in the axial second direction L2 of the stator St. In this example, a plurality of the first radial oil passages 29A (e.g., 3 to 12) are dispersed and arranged in the circumferential direction. The positions in the axial direction L of the first radial oil passages 29A are determined according to the position of the coil end portion Ce to be cooled.

The same number of second radial oil passages 29B as that of first radial direction oil passages 29A are dispersed and arranged in the circumferential direction. The axial oil passage 29C and the third radial oil passage 29D are placed at each of the positions in the circumferential direction corresponding to the plurality of second radial oil passages 29B. In the present embodiment, the second radial oil passages 29B are placed at different circumferential positions from the first radial oil passage 29A. As in the illustrated example, if the second radial oil passage 29B is located at a different position in the axial direction L from the first radial oil passage 29A, the second radial oil passage 29B may be located at the same position in the circumferential direction as the first radial oil passage 29A. The axial oil passage 29C is provided along the contact surface between the inner peripheral surface of the rotor body Ro and the outer peripheral surface of the rotor holding portion 25. In this example, the axial oil passage 29C is formed by a recessed groove formed in the outer peripheral surface of the rotor holding portion 25 so as to extend in the axial direction L. The third radial oil passage 29D is provided along the contact surface between an end plate Ep forming an end face on the side in the axial second direction L2 of the rotor body Re and an outer flange portion 25D extending in the radially outward direction R2 from an end on the side in the axial second direction L2 of the rotor holding portion 25. In this example, the third radial oil passage 29D is formed by a recessed groove that is formed in the surface on the side in the axial first direction L1 of the outer flange portion 25D so as to extend in the radial direction R.

According to this configuration, the oil collected by the oil collecting portion 25A can be separated by the first radial oil passages 29A and the second radial oil passages 29B which are dispersed and arranged in the circumferential direction, and the cooling oil can be supplied to the coil end portion Ce on the axial first direction L1 side and the coil end portion Ce on the axial second direction L2 side. Thus, the coil end portions Ce on both sides in the axial direction L of the stator St can be uniformly cooled.

### 5. Other Embodiments

Lastly, other embodiments of the vehicle drive device of the present invention will be described below. The configuration disclosed in each of the following embodiments may be combined with any of the configurations disclosed in the other embodiments as long as no inconsistency arises.

(1) The above embodiment is described with respect to an example in which the rotary housing 60 of the torque converter TC includes the stepped portion 63C, and the coupling-side joint portion 65 is positioned on the radially outward direction R2 side with respect to the stepped portion 63C so as to have a portion overlapping the stepped portion 63C as viewed in the radial direction R. However, embodiments of the present invention are not limited to this. It is also one of preferred embodiments of the present invention that the rotary housing 60 do not include the stepped portion 63C, or that in the case where the rotary housing 60 includes the stepped portion 63C, the coupling-side joint portion 65 be positioned so as not to overlap the stepped portion 63C as viewed in the radial direction R.

(2) The above embodiment is described with respect to an example in which the outer periphery-side fixing portion 82 of the flex plate 8 is fixed to the coupling-side joint portion 65 by the fastening bolt 85. However, embodiments of the present invention are not limited to this. A fixing method other than the fixing with the bolt may be used to fix the outer periphery-side fixing portion 82 to the coupling-side joint portion 65. Such a fixing method may be, e.g., a method using a rivet, welding, etc.

(3) The above embodiment is described with respect to an example in which the inner periphery-side fixing portion 83 of the flex plate 8 is fixed to the first flange portion 9B of the joint member 9 by the rivet 85. However, embodiments of the present invention are not limited to this. A fixing method other than the fixing with the rivet may be used to fix the flex plate 8 to the joint member 9. For example, a method such as fastening with a bolt, welding, etc. may be used.

(4) The above embodiment is described with respect to an example in which the rivet 87 that fixes the inner periphery-side fixing portion 83 of the flex plate 8 to the first flange portion 9B of the joint member 9 is placed along a direction parallel to the axial direction L. However, embodiments of the present invention are not limited to this. It is also one of preferred embodiments of the present invention that the rivet 87 be placed along a direction tilted with respect to the axial direction L. In this case, the inner periphery-side fixing portion 83 may be placed along a direction tilted with respect to the radial direction R.

(5) The above embodiment is described with respect to an example in which the rotor member 21 of the rotating electrical machine MG is coupled to the rotary housing 60 of the torque converter TC via the joint member 9 and the flex plate 8. However, the joint member 9 need not necessarily provided, and it is also preferable to couple the rotor member 21 to the rotary housing 60 only via the flex plate 60. In this case, if the partition wall (the first support partition wall 31) of the case 3 is present between the rotating electrical machine MG and the torque converter TC, it is preferable that the rotor member 21 include an axially extending portion extending on the radial direction R1 side with respect to the partition wall and extending toward the torque converter TC, and that the inner periphery-side fixing portion 83 of the flex plate 8 be fixed to the axially extending portion.

(6) The above embodiment is described with respect to an example in which the joint member 9 has the second flange portion 9C extending in the radially outward direction R2 from the first cylindrical protruding portion 40, and the engagement portion between the joint member 9 and the rotor support member 22 is located on the side of the radially outward direction R2 with respect to the first cylindrical protruding portion 40. However, embodiments of the present invention are not limited to this, and the rotor support member 22 may have a portion extending in the radially inward direction R1 from the first cylindrical protruding portion 40, and the engagement portion between the joint member 9 and the rotor support member 22 may be located on the radially inward direction R1 side with respect to the first cylindrical protruding portion 40. In such a configuration, the joint member 9 need not necessarily be formed by the two members, namely the first joint member 91 and the second joint member 92 as described above, and it is also preferable that the joint member 9 be formed only by a member corresponding to the first joint member 91.

(7) The above embodiment is described with respect to an example in which the first accommodating chamber 35 accommodating the rotating electrical machine MG is separated from the second accommodating chamber 36 accommodating the torque converter TC and the flex plate 8 by the first support wall portion 31 as a partition wall. However, embodiments of the present invention are not limited to this. It is also one of preferred embodiments of the present invention that the case 3 include no partition wall between the rotating electrical machine MG and the torque converter TC and the flex plate 8, and accommodate the rotating electrical machine MG, the torque converter TC, and the flex plate 8 in the same chamber.

(8) The above embodiment is described with respect to an example in which the opening 39 is provided in a portion of the peripheral wall portion 34 which will overlap the joint contact surface 65A as viewed in the direction perpendicular to the joint contact surface 65A. However, embodiments of the present invention are not limited to this. The opening 39 may be provided at a different position in the peripheral wall portion 34 from that described above, or the opening 39 that is used to perform the operation of fixing the flex plate 8 to the coupling-side joint portion 65 may not be provided in the case 3.

(9) The above embodiment is described with respect to an example in which the vehicle drive device 1 has a single-axis configuration. However, embodiments of the present invention are not limited to this, and the vehicle drive device 1 may be a drive device having a multi-axis configuration including, e.g., a counter gear mechanism etc. Such a drive device having a multi-axis configuration is suitable when being mounted on front engine front drive (FF) vehicles.

(10) The above embodiment is described with respect to an example in which the vehicle drive device 1 includes the input member 1 drivingly coupled to the internal combustion engine E, and the first clutch C1. However, embodiments of the present invention are not limited to this, and the vehicle drive device 1 may not include the input member I and the first clutch C1.

(11) Regarding other configurations as well, the embodiments disclosed in the specification are by way of example in all respects, and embodiments of the present invention are not limited to them. That is, the configurations that are not described in the claims can be modified as appropriate without departing from the object of the present invention.

The present invention can be used in vehicle drive devices that include a rotating electrical machine, and a fluid coupling placed on one side in the axial direction of the rotating electrical machine with respect to the rotating electrical machine and coaxially with the rotating electrical machine.

What is claimed is:

1. A vehicle drive device, comprising: a rotating electrical machine; and a fluid coupling placed on one side in an axial direction of the rotating electrical machine with respect to the rotating electrical machine, and coaxially with the rotating electrical machine, wherein
a rotor member of the rotating electrical machine is coupled to a rotary housing of the fluid coupling via a disk-like member,
the disk-like member is placed coaxially with the rotating electrical machine, and includes a disk-like main body, and an outer periphery-side fixing portion integrally formed outward in a radial direction of the disk-like main body,
the disk-like main body is formed in a shape of a disk that is placed between the rotating electrical machine and the fluid coupling in the axial direction, and that extends in the radial direction,
the fluid coupling includes a coupling-side joint portion to which the outer periphery-side fixing portion of the disk-like member is fixed,
the outer periphery-side fixing portion is formed in a shape of a truncated conical surface tilted with respect to the radial direction so that a diameter of the outer periphery-side fixing portion increases from the rotating electrical machine side to the fluid coupling side in the axial direction,
the coupling-side joint portion is fixed to the rotary housing at a position where the coupling-side joint portion has a portion overlapping the rotary housing as viewed in the axial direction, and includes a joint contact surface that is contacted by the outer periphery-side fixing portion, and
the joint contact surface is provided so as not to overlap the rotating electrical machine as viewed in a direction perpendicular to the joint contact surface.

2. The vehicle drive device according to claim 1, wherein
the rotating electrical machine is accommodated in a first accommodating chamber, the fluid coupling and the disk-like member are accommodated in a second accommodating chamber that is separated from the first accommodating chamber by a partition wall,
oil that is used to cool the rotating electrical machine is present in the first accommodating chamber, and
the joint contact surface is provided so as not to overlap the first accommodating chamber as viewed in the direction perpendicular to the joint contact surface.

3. The vehicle drive device according to claim 1, wherein
the rotating electrical machine is accommodated in a first accommodating chamber, the fluid coupling and the disk-like member are accommodated in a second accommodating chamber that is separated from the first accommodating chamber by a partition wall, and
a peripheral wall portion surrounds an outside in the radial direction of the second accommodating chamber, an opening is provided in a portion of the peripheral wall portion, and the portion of the peripheral wall portion includes a portion that will overlap the joint contact surface as viewed in the direction perpendicular to the joint contact surface.

4. The vehicle drive device according to claim 1, wherein
the rotating electrical machine is accommodated in a first accommodating chamber, the fluid coupling and the disk-like member are accommodated in a second accommodating chamber that is separated from the first accommodating chamber by a partition wall,
the rotor member is coupled to the disk-like member via a joint member,
the joint member includes a cylindrical portion formed in a cylindrical shape, and a flange portion which extends outward in the radial direction from the cylindrical portion in the second accommodating chamber and to which the disk-like member is fixed, and
a sealing member is provided between the partition wall and an outer peripheral surface of the joint member which is located on the rotating electrical machine side with respect to the flange portion.

5. The vehicle drive device according to claim 1, wherein
an opposing surface portion of the rotary housing which faces the disk-like member includes a radially outer portion, a radially inner portion located inward of the radially outer portion in the radial direction and located on the rotating electrical machine side in the axial direction with respect to the radially outer portion, and a stepped portion connecting the radially inner portion and the radially outer portion in the axial direction at a position between the radially inner portion and the radially outer portion in the radial direction, and
the coupling-side joint portion is fixed to the radially outer portion at a position where the coupling-side joint portion has a portion overlapping the stepped portion as viewed in the radial direction.

6. The vehicle drive device according to claim 1, wherein
the outer periphery-side fixing portion is fixed to the coupling-side joint portion by a fastening bolt that extends through the outer periphery-side fixing portion in a fastening direction from outside in the radial direction, and the fastening direction is a direction perpendicular to the joint contact surface.

7. The vehicle drive device according to claim 1, wherein
the rotor member is coupled to the disk-like member via a joint member,
the disk-like member includes an inner periphery-side fixing portion located inward of the disk-like main body in the radial direction, and
the inner periphery-side fixing portion is fixed to the joint member by a rivet that extends through the inner periphery-side fixing portion in a direction parallel to the axis direction.

8. The vehicle drive device according to claim 2, wherein
the rotating electrical machine is accommodated in a first accommodating chamber, the fluid coupling and the disk-like member are accommodated in a second accommodating chamber that is separated from the first accommodating chamber by a partition wall, and
a peripheral wall portion surrounds an outside in the radial direction of the second accommodating chamber, an opening is provided in a portion of the peripheral wall portion, and the portion of the peripheral wall portion includes a portion that will overlap the joint contact surface as viewed in the direction perpendicular to the joint contact surface.

9. The vehicle drive device according to claim 8, wherein
the rotating electrical machine is accommodated in a first accommodating chamber, the fluid coupling and the disk-like member are accommodated in a second accommodating chamber that is separated from the first accommodating chamber by a partition wall,
the rotor member is coupled to the disk-like member via a joint member,
the joint member includes a cylindrical portion formed in a cylindrical shape, and a flange portion which extends outward in the radial direction from the cylindrical portion in the second accommodating chamber and to which the disk-like member is fixed, and
a sealing member is provided between the partition wall and an outer peripheral surface of the joint member which is located on the rotating electrical machine side with respect to the flange portion.

10. The vehicle drive device according to claim 9, wherein
an opposing surface portion of the rotary housing which faces the disk-like member includes a radially outer portion, a radially inner portion located inward of the radially outer portion in the radial direction and located on the rotating electrical machine side in the axial direction with respect to the radially outer portion, and a stepped portion connecting the radially inner portion and the radially outer portion in the axial direction at a position between the radially inner portion and the radially outer portion in the radial direction, and
the coupling-side joint portion is fixed to the radially outer portion at a position where the coupling-side joint portion has a portion overlapping the stepped portion as viewed in the radial direction.

11. The vehicle drive device according to claim 10, wherein
the outer periphery-side fixing portion is fixed to the coupling-side joint portion by a fastening bolt that extends through the outer periphery-side fixing portion in a fastening direction from outside in the radial direction, and the fastening direction is a direction perpendicular to the joint contact surface.

12. The vehicle drive device according to claim 11, wherein
the rotor member is coupled to the disk-like member via a joint member,
the disk-like member includes an inner periphery-side fixing portion located inward of the disk-like main body in the radial direction, and
the inner periphery-side fixing portion is fixed to the joint member by a rivet that extends through the inner periphery-side fixing portion in a direction parallel to the axis direction.

13. The vehicle drive device according to claim 2, wherein
the rotating electrical machine is accommodated in a first accommodating chamber, the fluid coupling and the disk-like member are accommodated in a second accommodating chamber that is separated from the first accommodating chamber by a partition wall,
the rotor member is coupled to the disk-like member via a joint member,
the joint member includes a cylindrical portion formed in a cylindrical shape, and a flange portion which extends outward in the radial direction from the cylindrical portion in the second accommodating chamber and to which the disk-like member is fixed, and
a sealing member is provided between the partition wall and an outer peripheral surface of the joint member which is located on the rotating electrical machine side with respect to the flange portion.

14. The vehicle drive device according to claim 2, wherein
an opposing surface portion of the rotary housing which faces the disk-like member includes a radially outer portion, a radially inner portion located inward of the radially outer portion in the radial direction and located on the rotating electrical machine side in the axial direction with respect to the radially outer portion, and a stepped portion connecting the radially inner portion and the radially outer portion in the axial direction at a position between the radially inner portion and the radially outer portion in the radial direction, and
the coupling-side joint portion is fixed to the radially outer portion at a position where the coupling-side joint portion has a portion overlapping the stepped portion as viewed in the radial direction.

15. The vehicle drive device according to claim 2, wherein
the outer periphery-side fixing portion is fixed to the coupling-side joint portion by a fastening bolt that extends through the outer periphery-side fixing portion in a fastening direction from outside in the radial direction, and the fastening direction is a direction perpendicular to the joint contact surface.

16. The vehicle drive device according to claim 3, wherein
the rotating electrical machine is accommodated in a first accommodating chamber, the fluid coupling and the disk-like member are accommodated in a second accommodating chamber that is separated from the first accommodating chamber by a partition wall,
the rotor member is coupled to the disk-like member via a joint member,
the joint member includes a cylindrical portion formed in a cylindrical shape, and a flange portion which extends outward in the radial direction from the cylindrical portion in the second accommodating chamber and to which the disk-like member is fixed, and
a sealing member is provided between the partition wall and an outer peripheral surface of the joint member which is located on the rotating electrical machine side with respect to the flange portion.

17. The vehicle drive device according to claim 3, wherein
an opposing surface portion of the rotary housing which faces the disk-like member includes a radially outer portion, a radially inner portion located inward of the radially outer portion in the radial direction and located on the rotating electrical machine side in the axial direction with respect to the radially outer portion, and a stepped portion connecting the radially inner portion and the radially outer portion in the axial direction at a position between the radially inner portion and the radially outer portion in the radial direction, and
the coupling-side joint portion is fixed to the radially outer portion at a position where the coupling-side joint portion has a portion overlapping the stepped portion as viewed in the radial direction.

18. The vehicle drive device according to claim 3, wherein
the outer periphery-side fixing portion is fixed to the coupling-side joint portion by a fastening bolt that extends through the outer periphery-side fixing portion in a fastening direction from outside in the radial direction, and the fastening direction is a direction perpendicular to the joint contact surface.

19. The vehicle drive device according to claim 4, wherein
an opposing surface portion of the rotary housing which faces the disk-like member includes a radially outer portion, a radially inner portion located inward of the radially outer portion in the radial direction and located on the rotating electrical machine side in the axial direction with respect to the radially outer portion, and a stepped portion connecting the radially inner portion and the radially outer portion in the axial direction at a position between the radially inner portion and the radially outer portion in the radial direction, and
the coupling-side joint portion is fixed to the radially outer portion at a position where the coupling-side joint portion has a portion overlapping the stepped portion as viewed in the radial direction.

20. The vehicle drive device according to claim 4, wherein
the outer periphery-side fixing portion is fixed to the coupling-side joint portion by a fastening bolt that extends through the outer periphery-side fixing portion in a fastening direction from outside in the radial direction, and the fastening direction is a direction perpendicular to the joint contact surface.
